(19) United States
(12) Patent Application Publication
(10) Pub. No.: US 2026/0247336 A1
(43) Pub. Date: Aug. 20, 2026

(54) PASSIVE TRIGGER-BASED RANGING (TBR) BASED REPORTING

(71) Applicant: QUALCOMM Incorporated, San Diego, CA (US)

(72) Inventors: Akansh JAIN, Chennai (IN); Vinod BELUR RAMACHANDRA, Chennai (IN); G SRIRAM, Karaikudi (IN); Xiaoxin ZHANG, Sunnyvale, CA (US)

(21) Appl. No.: 19/054,187

(22) Filed: Feb. 14, 2025

(51) Int. Cl. H04W 64/00; H04L 1/1607; H04L 5/00

(52) U.S. Cl. CPC H04W 64/003; H04L 1/1685; H04L 5/0053

(57) ABSTRACT

In some implementations, a responding station (RSTA) may collect location reports from one or more passive stations (PSTAs) at least in part by transmitting a reporting trigger frame subsequent to at least one positioning operation performed by the one or more PSTAs, the reporting trigger frame soliciting location reports from the one or more PSTAs. In addition, the RSTA may, subsequent to transmitting the reporting trigger frame, receive, from each respective PSTA of the one or more PSTAs, a respective location report having respective location information of the respective PSTA, where the respective location information is determined by the respective PSTA based at least in part on the at least one positioning operation performed by the one or more PSTAs.

### BACKGROUND

### 1. Field of Disclosure

The present disclosure generally relates to the field of radio frequency (RF)-based ranging and, more specifically, to coordinating passive trigger-based ranging (TBR) between wireless devices.

### 2. Description of Related Art

In modern wireless communication systems, accurate location estimation plays an important role in a wide range of applications, including indoor navigation, asset tracking, and location-based services. The Institute of Electrical and Electronics Engineers (IEEE) 802.11az and 802.11bk standards introduce significant enhancements to support high-accuracy positioning using existing Wi-Fi infrastructure. One of the features of these standards is passive TBR, which facilitates precise location estimation without requiring active transmission from the device being located.

### BRIEF SUMMARY

Embodiments described herein provide a new series of communication frames for post-positioning passive station (PSTA) reporting. Depending on desired functionality and network type, this reporting may be provided to a central controller and/or other devices. Because PSTAs determine their position passively by listening to transmissions by other stations (STAs), these new communication frames provide an awareness of PSTA positions. In a network of moving devices, this can enable the controller and/or other devices to navigate accordingly, with an awareness of PSTA positions that the controller and/or other devices otherwise would not have. As detailed herein, embodiments may include pulling frames and/or broadcasting frames, as needed, which may depend on the network type and/or application.

An example method performed by a responding station (RSTA) of collecting location reports from one or more passive stations (PSTAs), according to this disclosure, comprises transmitting a reporting trigger frame subsequent to at least one positioning operation performed by the one or more PSTAs, the reporting trigger frame soliciting location reports from the one or more PSTAs. The method further may comprise, subsequent to transmitting the reporting trigger frame, receiving, from each respective PSTA of the one or more PSTAs, a respective location report comprising respective location information of the respective PSTA, wherein the respective location information is determined by the respective PSTA based at least in part on the at least one positioning operation performed by the one or more PSTAs.

An example method of reporting location-related information, performed by a passive station (PSTA), according to this disclosure, comprises performing at least one positioning operation without transmitting radio frequency (RF) signals, and determining location information of the PSTA based at least in part on the at least one positioning operation. The method further may comprise, subsequent to performing the at least one positioning operation, receiving a reporting trigger frame from a responding station (RSTA), the reporting trigger frame soliciting a location report from the PSTA, and responsive to receiving the reporting trigger frame, transmitting a location report, the location report comprising the determined location information of the PSTA.

An example responding station (RSTA), according to this disclosure, comprises at least one transceiver; at least one memory; and at least one processor communicatively coupled with the at least one transceiver and the at least one memory. The at least one processor is configured to transmit, via the at least one transceiver, a reporting trigger frame subsequent to at least one positioning operation performed by one or more passive stations (PSTAs), the reporting trigger frame soliciting location reports from the one or more PSTAs. The at least one processor is also configured to, subsequent to transmitting the reporting trigger frame, receiving, via the at least one transceiver, from each respective PSTA of the one or more PSTAs, a respective location report comprising respective location information of the respective PSTA, wherein the respective location information is determined by the respective PSTA based at least in part on the at least one positioning operation performed by the one or more PSTAs.

An example passive station (PSTA), according to this disclosure, comprises at least one transceiver; at least one memory; and at least one processor communicatively coupled with the at least one transceiver and the at least one memory. The at least one processor is configured to perform at least one positioning operation without transmitting radio frequency (RF) signals and determine location information of the PSTA based at least in part on the at least one positioning operation. The at least one processor is also configured to, subsequent to performing the at least one positioning operation, receive a reporting trigger frame, via the at least one transceiver, from a responding station (RSTA), the reporting trigger frame soliciting a location report from the PSTA. The at least one processor is also configured to, responsive to receiving the reporting trigger frame, transmit a location report via the at least one transceiver, the location report comprising the determined location information of the PSTA.

This summary is neither intended to identify key or essential features of the claimed subject matter nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is a diagram of a positioning system, according to an embodiment.

FIG. 2 is a diagram of block diagram of an example wireless communication network.

FIG. 3 is a diagram showing an example environment in which passive trigger-based ranging (TBR) for a passive station (PSTA) may be performed.

FIG. 4 is a diagram showing an example of a radio frame sequence for passive TBR, according to an embodiment.

FIG. 5 is a timing diagram showing an example passive TBR measurement exchange for passive ranging a PSTA, according to an embodiment.

FIG. 6A-6C are diagrams of different types of device networks that may benefit from the use of passive TBR for the positioning of devices, according to an embodiment.

FIG. 7 is a diagram of a radio frame sequence, illustrating new frames that may be utilized in accordance with embodiments herein as part of a PSTA collection and reporting phase, according to an embodiment.

FIGS. 8A-8D are diagrams of specific subsets of the radio frame sequence of FIG. 7 that may be used in different embodiments.

FIGS. 9A-9D are diagrams of specific subsets of the radio frame sequence of FIG. 7 that are used in example scenarios described herein.

FIG. 10 is a flow diagram of method performed by a responding station (RSTA) of collecting location reports from one or more PSTAs, according to an embodiment.

FIG. 11 is a flow diagram of method of reporting location information performed by a PSTA, according to an embodiment.

FIG. 12 is a block diagram of an embodiment of a wireless device, which can be utilized in embodiments as described herein.

Like reference symbols in the various drawings indicate like elements in accordance with certain example implementations. In addition, multiple instances of an element may be indicated by following a first number for the element with a letter or a hyphen and a second number. For example, multiple instances of an element 110 may be indicated as 110-1, 110-2, 110-3, etc., or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

The following description is directed to certain implementations for the purposes of describing innovative aspects of various embodiments. However, a person having ordinary skill in the art will readily recognize that the teachings herein can be applied in a multitude of different ways. The described implementations may be implemented in any device, system, or network that is capable of transmitting and receiving radio frequency (RF) signals according to any communication standard, such as any of the Institute of Electrical and Electronics Engineers (IEEE) IEEE 802.11 standards (including those identified as Wi-Fi® technologies), the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Rate Packet Data (HRPD), High Speed Packet Access (HSPA), High Speed Downlink Packet Access (HSDPA), High Speed Uplink Packet Access (HSUPA), Evolved High Speed Packet Access (HSPA+), Long Term Evolution (LTE), Advanced Mobile Phone System (AMPS), or other known signals that are used to communicate within a wireless, cellular or internet of things (IoT) network, such as a system utilizing 3G, 4G, 5G, 6G, or further implementations thereof, technology.

As used herein, an “RF signal” comprises an electromagnetic wave that transports information through the space between a transmitter (or transmitting device) and a receiver (or receiving device). As used herein, a transmitter may transmit a single “RF signal” or multiple “RF signals” to a receiver. However, the receiver may receive multiple “RF signals” corresponding to each transmitted RF signal due to the propagation characteristics of RF signals through multiple channels or paths.

Additionally, unless otherwise specified, references to “reference signals,” “positioning reference signals,” “reference signals for positioning,” and the like may be used to refer to signals used for positioning of a user equipment (UE). As described in more detail herein, such signals may comprise any of a variety of signal types but may not necessarily be limited to signals specifically designated for positioning as defined in relevant wireless standards. Additional or alternative signal types may be used, depending on desired functionality.

Further, unless otherwise specified, the term “positioning” as used herein may absolute location determination, relative location determination, ranging, or a combination thereof. Such positioning may include and/or be based on timing, angular, phase, or power measurements, or a combination thereof (which may include RF sensing measurements) for the purpose of location or sensing services. Thus, a “report” of a position may be reflective of the type of positioning determined. Relevant standards may indicate what type of information is included in such reports.

As previously noted, IEEE 802.11az and 802.11bk standards provide for the positioning of passive stations (PSTAs) through a trigger-based ranging (TBR) operation between a responding STA (RSTA) and multiple initiating STAs (ISTAs). However, such passive TBR allows each PSTA to determine its own position without necessarily knowing the position of any other PSTAs that may be nearby. For groups of devices that may need to navigate around each other (e.g., Internet of Things (IoT) robots on a factory floor, flying vehicles, connected self-driving cars, etc.), the coordination of movements among devices may be needed to help avoid collision. Further, a knowledge of the location of each device may be needed by one or more coordinating devices (e.g., a controller and/or the devices themselves) to enable such movement coordination. However, this knowledge is not provided to the one or more coordinating devices as part of the passive TBR process.

Embodiments described herein address these and other issues by providing new PSTA collection and reporting frames that can a company a passive TBR process to enable the sharing of PSTA location information. Various aspects relate generally to location reporting by PSTAs. Some aspects more specifically relate to one or more PSTAs providing respective location reports in response to a trigger frame (TF) sent by an RSTA. In some examples, the RSTA may first send a TF poll to determine the PSTAs that will provide the location reports, to which the one or more PSTAs can send an acknowledgment. In some examples, the RSTA may then broadcast the collected locations to a controller (e.g., in a centralized network) and/or one or more devices (e.g., in a decentralized or hybrid network). These new PSTA collection and reporting frames can follow a traditional passive TBR process, and/or may be utilized in conjunction with other types of location determination (e.g., global navigation satellite system (GNSS)-based positioning). Additional details are provided in the embodiments below.

Particular aspects of the subject matter described in this disclosure can be implemented to realize one or more of the following potential advantages. In some examples, by providing a means by which PSTAs can report their position, the described techniques can be used to help facilitate the coordination of device movement within a group of (wireless) mobile devices. Further, by utilizing the new PSTA collection and reporting frames together with passive TBR, device location estimation may be shared with minimal impact on network throughput. Additionally, embodiments may use security measures, such as medium access control (MAC) only security encryption, to help ensure the PSTA collection and reporting frames are communicated securely. Additional details will follow after an initial description of relevant systems and technologies.

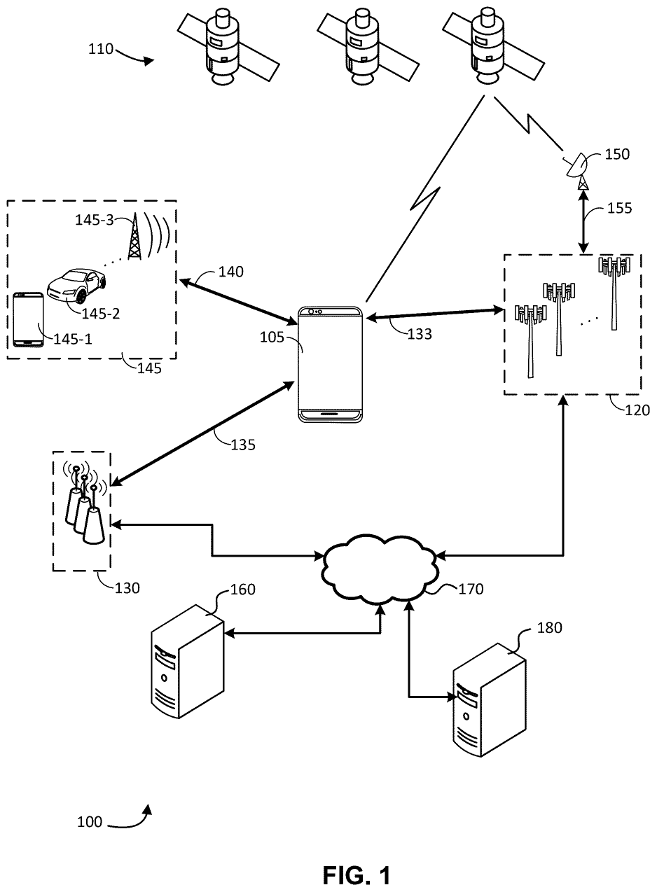

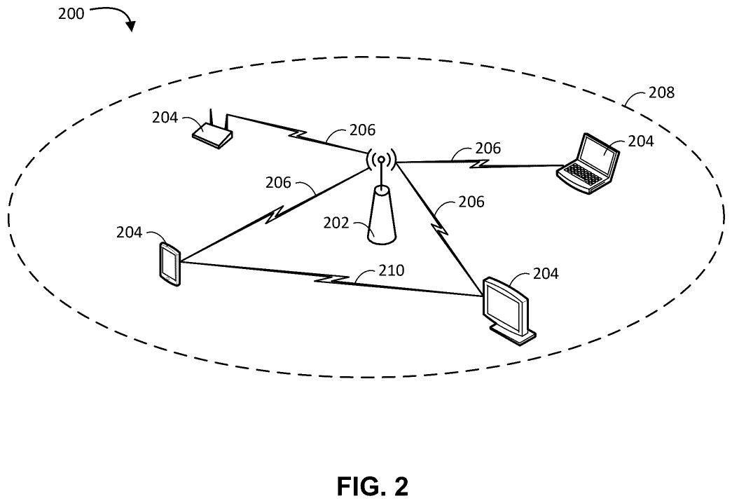

FIG. 1 is a simplified illustration of a positioning system 100 in which a mobile device 105, location server 160, and/or other components of the positioning system 100 can use the techniques provided herein for passive TBR-based positioning and/or reporting, according to an embodiment. The techniques described herein may be implemented by one or more components of the positioning system 100. However, the techniques described herein are not limited to such components and may be implemented in other types of systems (not shown). The positioning system 100 can include: a mobile device 105; one or more satellites 110 (also referred to as space vehicles (SVs)) for a Global Navigation Satellite System (GNSS) (e.g., the Global Positioning System (GPS), GLONASS, Galileo, or Beidou) and/or Non-Terrestrial Network (NTN) functionality; base stations 120; access points (APs) 130; location server 160; network 170; and external client 180. Mobile device 105 may also refer to a STA, user equipment (UE), or other wireless device (or vice versa) in some contexts of the present disclosure. Generally put, the positioning system 100 can estimate a location of the mobile device 105 based on RF signals received by and/or sent from the mobile device 105 and known locations of other components (e.g., GNSS satellites 110, base stations 120, APs 130) transmitting and/or receiving the RF signals. Additionally or alternatively, wireless devices such as the mobile device 105, base stations 120, and satellites 110 (and/or other NTN platforms, which may be implemented on airplanes, drones, balloons, etc.) can be utilized to perform positioning (e.g., of one or more wireless devices) and/or perform RF sensing (e.g., of one or more objects by using RF signals transmitted by one or more wireless devices). Additional details regarding particular location estimation techniques are discussed in more detail with regard to FIG. 2.

It should be noted that FIG. 1 provides only a generalized illustration of various components, any or all of which may be utilized as appropriate, and each of which may be duplicated as necessary. Specifically, although only one mobile device 105 is illustrated, it will be understood that many UEs (e.g., hundreds, thousands, millions, etc.) may utilize the positioning system 100. Similarly, the positioning system 100 may include a larger or smaller number of base stations 120 and/or APs 130 than illustrated in FIG. 1. The illustrated connections that connect the various components in the positioning system 100 comprise data and signaling connections which may include additional (intermediary) components, direct or indirect physical and/or wireless connections, and/or additional networks. Furthermore, components may be rearranged, combined, separated, substituted, and/or omitted, depending on desired functionality. In some embodiments, for example, the external client 180 may be directly connected to location server 160. A person of ordinary skill in the art will recognize many modifications to the components illustrated.

Depending on desired functionality, the network 170 may comprise any of a variety of wireless and/or wireline networks. The network 170 can, for example, comprise any combination of public and/or private networks, local and/or wide-area networks, and the like. Furthermore, the network 170 may utilize one or more wired and/or wireless communication technologies. In some embodiments, the network 170 may comprise a cellular or other mobile network, a wireless local area network (WLAN), a wireless wide-area network (WWAN), and/or the Internet, for example. Examples of network 170 include a Long-Term Evolution (LTE) wireless network, a Fifth Generation (5G) wireless network (also referred to as New Radio (NR) wireless network or 5G NR wireless network), a Wi-Fi WLAN, and the Internet. LTE, 5G and NR are wireless technologies defined, or being defined, by the 3rd Generation Partnership Project (3GPP). Network 170 may also include more than one network and/or more than one type of network.

The base stations 120 and access points (APs) 130 may be communicatively coupled to the network 170. In some embodiments, the base station 120s may be owned, maintained, and/or operated by a cellular network provider, and may employ any of a variety of wireless technologies, as described herein below. Depending on the technology of the network 170, a base station 120 may comprise a node B, an Evolved Node B (eNodeB or eNB), a base transceiver station (BTS), a radio base station (RBS), an NR NodeB (gNB), a Next Generation eNB (ng-eNB), or the like. A base station 120 that is a gNB or ng-eNB may be part of a Next Generation Radio Access Network (NG-RAN) which may connect to a 5G Core Network (5GC) in the case that Network 170 is a 5G network. The functionality performed by a base station 120 in earlier-generation networks (e.g., 3G and 4G) may be separated into different functional components (e.g., radio units (RUs), distributed units (DUs), and central units (CUs)) and layers (e.g., L1/L2/L3) in view Open Radio Access Networks (O-RAN) and/or Virtualized Radio Access Network (V-RAN or vRAN) in 5G or later networks, which may be executed on different devices at different locations connected, for example, via fronthaul, midhaul, and backhaul connections. As referred to herein, a “base station” (or ng-eNB, gNB, etc.) may include any or all of these functional components. An AP 130 may comprise a Wi-Fi AP or a Bluetooth® AP or an AP having cellular capabilities (e.g., 4G LTE and/or 5G NR), for example. When performing positioning in accordance with 802.11 standards, APs 130 and/or mobile device 105 may comprise stations or STAs, which are described in more detail in the embodiments below. Thus, mobile device 105 can send and receive information with network-connected devices, such as location server 160, by accessing the network 170 via a base station 120 using a first communication link 133. Additionally, or alternatively, because APs 130 also may be communicatively coupled with the network 170, mobile device 105 may communicate with network-connected and Internet-connected devices, including location server 160, using a second communication link 135, or via one or more other mobile devices 145.

As used herein, the term “base station” may generically refer to a single physical transmission point, or multiple co-located physical transmission points, which may be located at a base station 120. A Transmission Reception Point (TRP) (also known as transmit/receive point) corresponds to this type of transmission point, and the term “TRP” may be used interchangeably herein with the terms “gNB,” “ng-eNB,” and “base station.” In some cases, a base station 120 may comprise multiple TRPs—e.g. with each TRP associated with a different antenna or a different antenna array for the base station 120. As used herein, the transmission functionality of a TRP may be performed with a transmission point (TP) and/or the reception functionality of a TRP may be performed by a reception point (RP), which may be physically separate or distinct from a TP. That said, a TRP may comprise both a TP and an RP. Physical transmission points may comprise an array of antennas of a base station 120 (e.g., as in a Multiple Input-Multiple Output (MIMO) system and/or where the base station employs beamforming). According to aspects of applicable 5G cellular standards, a base station 120 (e.g., gNB) may be capable of transmitting different “beams” in different directions and performing “beam sweeping” in which a signal is transmitted in different beams, along different directions (e.g., one after the other). The term “base station” may additionally refer to multiple non-co-located physical transmission points, where the physical transmission points may be a Distributed Antenna System (DAS) (a network of spatially separated antennas connected to a common source via a transport medium) or a Remote Radio Head (RRH) (a remote base station connected to a serving base station).

As noted, satellites 110 may be used to implement NTN functionality, extending communication, positioning, and potentially other functionality (e.g., RF sensing) of a terrestrial network. As such, one or more satellites may be communicatively linked to one or more NTN gateways 150 (also known as “gateways,” “earth stations,” or “ground stations”). The NTN gateways 150 may be communicatively linked with base stations 120 via link 155. In some embodiments, NTN gateways 150 may function as DUs of a base station 120, as described previously. Not only can this enable the mobile device 105 to communicate with the network 170 via satellites 110, but this can also enable network-based positioning, RF sensing, etc.

Satellites 110 may be utilized in one or more ways. For example, satellites 110 (also referred to as space vehicles (SVs)) may be part of a Global Navigation Satellite System (GNSS) such as the Global Positioning System (GPS), GLONASS, Galileo or Beidou. Positioning using RF signals from GNSS satellites may comprise measuring multiple GNSS signals at a GNSS receiver of the mobile device 105 to perform code-based and/or carrier-based positioning, which can be highly accurate. Additionally, or alternatively, satellites 110 may be utilized for NTN-based positioning, in which satellites 110 may functionally operate as TRPs (or TPs) of a network (e.g., LTE and/or NR network) and may be communicatively coupled with network 170. In particular, reference signals (e.g., PRS) transmitted by satellites 110 NTN-based positioning may be similar to those transmitted by base stations 120 and may be coordinated by a network function server, which may operate as a location server 160. In some embodiments, satellites 110 used for NTN-based positioning may be different than those used for GNSS-based positioning. In some embodiments NTN nodes may include non-terrestrial vehicles such as airplanes, balloons, drones, etc., which may be in addition or as an alternative to NTN satellites. NTN satellites 110 and/or other NTN platforms may be further leveraged to perform RF sensing. As described in more detail hereafter, satellites may use a JCS symbol in an Orthogonal Frequency-Division Multiplexing (OFDM) waveform to allow both RF sensing and/or positioning, and communication.

As used herein, the term “cell” may generically refer to a logical communication entity used for communication with a base station 120, and may be associated with an identifier for distinguishing neighboring cells (e.g., a Physical Cell Identifier (PCID), a Virtual Cell Identifier (VCID)) operating via the same or a different carrier. In some examples, a carrier may support multiple cells, and different cells may be configured according to different protocol types (e.g., Machine-Type Communication (MTC), Narrowband Internet-of-Things (NB-IoT), Enhanced Mobile Broadband (eMBB), or others) that may provide access for different types of devices. In some cases, the term “cell” may refer to a portion of a geographic coverage area (e.g., a sector) over which the logical entity operates.

The location server 160 may comprise a server and/or other computing device configured to determine an estimated location of mobile device 105 and/or provide data (e.g., “assistance data”) to mobile device 105 to facilitate location measurement and/or location determination by mobile device 105. According to some embodiments, location server 160 may comprise a Home Secure User Plane Location (SUPL) Location Platform (H-SLP), which may support the SUPL user plane (UP) location solution defined by the Open Mobile Alliance (OMA) and may support location services for mobile device 105 based on subscription information for mobile device 105 stored in location server 160. In some embodiments, the location server 160 may comprise a Discovered SLP (D-SLP) or an Emergency SLP (E-SLP). The location server 160 may also comprise an Enhanced Serving Mobile Location Center (E-SMLC) that supports location of mobile device 105 using a control plane (CP) location solution for LTE radio access by mobile device 105. The location server 160 may further comprise a Location Management Function (LMF) that supports location of mobile device 105 using a control plane (CP) location solution for NR or LTE radio access by mobile device 105.

In a CP location solution, signaling to control and manage the location of mobile device 105 may be exchanged between elements of network 170 and with mobile device 105 using existing network interfaces and protocols and as signaling from the perspective of network 170. In a UP location solution, signaling to control and manage the location of mobile device 105 may be exchanged between location server 160 and mobile device 105 as data (e.g. data transported using the Internet Protocol (IP) and/or Transmission Control Protocol (TCP)) from the perspective of network 170.

As previously noted (and discussed in more detail below), the estimated location of mobile device 105 may be based on measurements of RF signals sent from and/or received by the mobile device 105. In particular, these measurements can provide information regarding the relative distance and/or angle of the mobile device 105 from one or more components in the positioning system 100 (e.g., satellites 110, APs 130, base stations 120). The estimated location of the mobile device 105 can be estimated geometrically (e.g., using multiangulation and/or multilateration), based on the distance and/or angle measurements, along with known position of the one or more components.

Additionally, or alternatively, the location server 160, may function as a sensing server. A sensing server can be used to coordinate and/or assist in the coordination of sensing of one or more objects (also referred to herein as “targets”) by one or more wireless devices in the positioning system 100. This can include the mobile device 105, base stations 120, APs 130, other mobile devices 145, satellites 110, or any combination thereof. Wireless devices capable of performing RF sensing may be referred to herein as “sensing nodes.” To perform RF sensing, a sensing server may coordinate sensing sessions in which one or more RF sensing nodes may perform RF sensing by transmitting RF signals (e.g., reference signals (RSs)), and measuring reflected signals, or “echoes,” comprising reflections of the transmitted RF signals off of one or more objects/targets. Reflected signals and object/target detection may be determined, for example, from channel state information (CSI) received at a receiving device. Sensing may comprise (i) monostatic sensing using a single device as a transmitter (of RF signals) and receiver (of reflected signals); (ii) bistatic sensing using a first device as a transmitter and a second device as a receiver; or (iii) multi-static sensing using a plurality of transmitters and/or a plurality of receivers. To facilitate sensing (e.g., in a sensing session among one or more sensing nodes), a sensing server may provide data (e.g., “assistance data”) to the sensing nodes to facilitate RS transmission and/or measurement, object/target detection, or any combination thereof. Such data may include an RS configuration indicating which resources (e.g., time and/or frequency resources) may be used (e.g., in a sensing session) to transmit RS for RF sensing. According to some embodiments, a sensing server may comprise a Sensing Management Function (SMF or SnMF).

Although terrestrial components such as APs 130 and base stations 120 may be fixed, embodiments are not so limited. Mobile components may be used. For example, in some embodiments, a location of the mobile device 105 may be estimated at least in part based on measurements of RF signals 140 communicated between the mobile device 105 and one or more other mobile devices 145, which may be mobile or fixed. As illustrated, other mobile devices may include, for example, a mobile phone 145-1, vehicle 145-2, static communication/positioning device 145-3, or other static and/or mobile device capable of providing wireless signals used for positioning the mobile device 105, or a combination thereof. Wireless signals from mobile devices 145 used for positioning of the mobile device 105 may comprise RF signals using, for example, Bluetooth® (including Bluetooth Low Energy (BLE)), IEEE 802.11x (e.g., Wi-Fi®), Ultra Wideband (UWB), IEEE 802.15x, or a combination thereof. Mobile devices 145 may additionally or alternatively use non-RF wireless signals for positioning of the mobile device 105, such as infrared signals or other optical technologies.

Mobile devices 145 may comprise other UEs communicatively coupled with a cellular or other mobile network (e.g., network 170). When one or more other mobile devices 145 comprising UEs are used in the position determination of a particular mobile device 105, the mobile device 105 for which the position is to be determined may be referred to as the “target UE,” and each of the other mobile devices 145 used may be referred to as an “anchor UE.” For position determination of a target UE, the respective positions of the one or more anchor UEs may be known and/or jointly determined with the target UE. Direct communication between the one or more other mobile devices 145 and mobile device 105 may comprise sidelink and/or similar Device-to-Device (D2D) communication technologies. Sidelink, which is defined by 3GPP, is a form of D2D communication under the cellular-based LTE and NR standards. UWB may be one such technology by which the positioning of a target device (e.g., mobile device 105) may be facilitated using measurements from one or more anchor devices (e.g., mobile devices 145).

According to some embodiments, such as when the mobile device 105 comprises and/or is incorporated into a vehicle, a form of D2D communication used by the mobile device 105 may comprise vehicle-to-everything (V2X) communication. V2X is a communication standard for vehicles and related entities to exchange information regarding a traffic environment. V2X can include vehicle-to-vehicle (V2V) communication between V2X-capable vehicles, vehicle-to-infrastructure (V2I) communication between the vehicle and infrastructure-based devices (commonly termed roadside units (RSUs)), vehicle-to-person (V2P) communication between vehicles and nearby people (pedestrians, cyclists, and other road users), and the like. Further, V2X can use any of a variety of wireless RF communication technologies. Cellular V2X (CV2X), for example, is a form of V2X that uses cellular-based communication such as LTE (4G), NR (5G) and/or other cellular technologies in a direct-communication mode as defined by 3GPP. The mobile device 105 illustrated in FIG. 1 may correspond to a component or device on a vehicle, RSU, or other V2X entity that is used to communicate V2X messages. In embodiments in which V2X is used, the static communication/positioning device 145-3 (which may correspond with an RSU) and/or the vehicle 145-2, therefore, may communicate with the mobile device 105 and may be used to determine the position of the mobile device 105 using techniques similar to those used by base stations 120 and/or APs 130 (e.g., using multiangulation and/or multilateration). It can be further noted that mobile devices 145 (which may include V2X devices), base stations 120, and/or APs 130 may be used together (e.g., in a WWAN positioning solution) to determine the position of the mobile device 105, according to some embodiments.

In some embodiments, a computerized device or system configured to collect information about the mobile device 105 may be communicatively coupled with mobile device 105 or included or disposed in mobile device 105. Whether disposed in the mobile device 105 or coupled with the mobile device 105, this computerized device, or system may be considered to be part of the mobile device 105 in some cases. In some implementations, this computerized device or system may include on-board diagnostics (OBD), which may reside inside of (or coupled with) a vehicle and, among other things, track a motion parameter (e.g., speed or velocity) or other performance metric(s) of the vehicle. Coupling may be done via a controller area network (CAN) bus, as shown, and collectively the computerized device or system may be referred to as OBD/CAN. OBD may collect information from its own sensors or other sensors of the vehicle, such as a vehicle speed sensor. OBD may also display or provide information (e.g., regarding speed or other diagnostic information) to the mobile device 105 or its user. Vehicle speed may be useful reference information in embodiments that will be described below.

An estimated location of mobile device 105 can be used in a variety of applications—e.g. to assist direction finding or navigation for a user of mobile device 105 or to assist another user (e.g. associated with external client 180) to locate mobile device 105. A “location” is also referred to herein as a “location estimate”, “estimated location”, “location”, “position”, “position estimate”, “position fix”, “estimated position”, “location fix” or “fix”. The process of determining a location may be referred to as “positioning,” “position determination,” “location determination,” or the like. A location of mobile device 105 may comprise an absolute location of mobile device 105 (e.g. a latitude and longitude and possibly altitude) or a relative location of mobile device 105 (e.g. a location expressed as distances north or south, east or west and possibly above or below some other known fixed location (including, e.g., the location of a base station 120 or AP 130) or some other location such as a location for mobile device 105 at some known previous time, or a location of a mobile device 145 (e.g., another UE) at some known previous time). A location may be specified as a geodetic location comprising coordinates which may be absolute (e.g. latitude, longitude and optionally altitude), relative (e.g. relative to some known absolute location) or local (e.g. X, Y and optionally Z coordinates according to a coordinate system defined relative to a local area such a factory, warehouse, college campus, shopping mall, sports stadium or convention center). A location may instead be a civic location and may then comprise one or more of a street address (e.g. including names or labels for a country, state, county, city, road and/or street, and/or a road or street number), and/or a label or name for a place, building, portion of a building, floor of a building, and/or room inside a building etc. A location may further include an uncertainty or error indication, such as a horizontal and possibly vertical distance by which the location is expected to be in error or an indication of an area or volume (e.g. a circle or ellipse) within which mobile device 105 is expected to be located with some level of confidence (e.g. 95% confidence).

The external client 180 may be a web server or remote application that may have some association with mobile device 105 (e.g. may be accessed by a user of mobile device 105) or may be a server, application, or computer system providing a location service to some other user or users which may include obtaining and providing the location of mobile device 105 (e.g. to enable a service such as friend or relative finder, or child or pet location). Additionally, or alternatively, the external client 180 may obtain and provide the location of mobile device 105 to an emergency services provider, government agency, etc.

As indicated in the description above, positioning system 100 may utilize aspects of various technologies, including GNSS, cellular (e.g., 5G) communications, 802.11 (e.g., Wi-Fi), and the like. FIG. 2, described below, illustrates how a communication network utilizing 802.11. This may be implemented as part of the positioning system 100, and may be implemented using APs 130, mobile device 105, and/or other mobile devices 145, for example.

FIG. 2 shows a block diagram of an example wireless communication network 200. According to some aspects, the wireless communication network 200 can be an example of a wireless local area network (WLAN) such as a Wi-Fi network (and will hereinafter be referred to as WLAN 200). For example, the WLAN 200 can be a network implementing at least one of the IEEE 802.11 family of wireless communication protocol standards (such as that defined by the IEEE 802.11-2016 specification or amendments thereof including, but not limited to, 802.11ay, 802.11ax, 802.11az, 802.11ba, 802.11be, and 802.11bk). The WLAN 200 may include numerous wireless communication devices such as an access point (AP) 202 and multiple stations (STAs) 204. While only one AP 202 is shown, the WLAN network 200 can also include multiple APs 202. Again, the wireless communication network 200 may be implemented using components of a positioning system 100. For example, an AP 130 of FIG. 1 may correspond with the AP 202 of FIG. 2. Additionally, or alternatively, the mobile device 105 and/or other mobile devices 145 of FIG. 1 may correspond with STAs 204 of FIG. 2.

Each of the STAs 204 also may be referred to as a mobile station (MS), a mobile device, a mobile handset, a wireless handset, an access terminal (AT), a user equipment (UE), a subscriber station (SS), or a subscriber unit, among other possibilities. The STAs 204 may represent various devices such as mobile phones, personal digital assistant (PDAs), other handheld devices, netbooks, notebook computers, tablet computers, laptops, display devices (for example, TVs, computer monitors, navigation systems, among others), music or other audio or stereo devices, remote control devices (“remotes”), printers, kitchen or other household appliances, key fobs (for example, for passive keyless entry and start (PKES) systems), among other possibilities.

A single AP 202 and an associated set of STAs 204 may be referred to as a basic service set (BSS), which is managed by the respective AP 202. FIG. 2 additionally shows an example coverage area 206 of the AP 202, which may represent a basic service area (BSA) of the WLAN 200. The BSS may be identified to users by a service set identifier (SSID), as well as to other devices by a basic service set identifier (BSSID), which may be a medium access control (MAC) address of the AP 202. The AP 202 periodically broadcasts beacon frames (“beacons”) including the BSSID to enable any STAs 204 within wireless range of the AP 202 to “associate” or re-associate with the AP 202 to establish a respective communication link 208 (hereinafter also referred to as a “Wi-Fi link”), or to maintain a communication link 208, with the AP 202. For example, the beacons can include an identification of a primary channel used by the respective AP 202 as well as a timing synchronization function for establishing or maintaining timing synchronization with the AP 202. The AP 202 may provide access to external networks to various STAs 204 in the WLAN via respective communication links 208.

To establish a communication link 208 with an AP 202, each of the STAs 204 is configured to perform passive or active scanning operations (“scans”) on frequency channels in one or more frequency bands (for example, the 2.4 GHz, 5 GHz, 6 GHz or 60 GHz bands). To perform passive scanning, a STA 204 listens for beacons, which are transmitted by respective APs 202 at a periodic time interval referred to as the target beacon transmission time (TBTT) (measured in time units (TUs) where one TU may be equal to 2024 microseconds (μs)). To perform active scanning, a STA 204 generates and sequentially transmits probe requests on each channel to be scanned and listens for probe responses from APs 202. Each STA 204 may be configured to identify or select an AP 202 with which to associate based on the scanning information obtained through the passive or active scans, and to perform authentication and association operations to establish a communication link 208 with the selected AP 202. The AP 202 assigns an association identifier (AID) to the STA 204 at the culmination of the association operations, which the AP 202 uses to track the STA 204.

As a result of the increasing ubiquity of wireless networks, a STA 204 may have the opportunity to select one of many BSSs within range of the STA or to select among multiple APs 202 that together form an extended service set (ESS) including multiple connected BSSs. An extended network station associated with the WLAN 200 may be connected to a wired or wireless distribution system that may allow multiple APs 202 to be connected in such an ESS. As such, a STA 204 can be covered by more than one AP 202 and can associate with different APs 202 at different times for different transmissions. Additionally, after association with an AP 202, a STA 204 also may be configured to periodically scan its surroundings to find a more suitable AP 202 with which to associate. For example, a STA 204 that is moving relative to its associated AP 202 may perform a “roaming” scan to find another AP 202 having more desirable network characteristics such as a greater received signal strength indicator (RSSI) or a reduced traffic load.

In some cases, STAs 204 may form networks without APs 202 or other equipment other than the STAs 204 themselves. One example of such a network is an ad hoc network (or wireless ad hoc network). Ad hoc networks may alternatively be referred to as mesh networks or peer-to-peer (P2P) networks. In some cases, ad hoc networks may be implemented within a larger wireless network such as the WLAN 200. In such implementations, while the STAs 204 may be capable of communicating with each other through the AP 202 using communication links 208, STAs 204 also can communicate directly with each other via direct wireless links 210. Additionally, two STAs 204 may communicate via a direct communication link 210 regardless of whether both STAs 204 are associated with and served by the same AP 202. In such an ad hoc system, one or more of the STAs 204 may assume the role filled by the AP 202 in a BSS. Such a STA 204 may be referred to as a group owner (GO) and may coordinate transmissions within the ad hoc network. Examples of direct wireless links 210 include Wi-Fi Direct connections, connections established by using a Wi-Fi Tunneled Direct Link Setup (TDLS) link, and other P2P group connections.

The APs 202 and STAs 204 may function and communicate (via the respective communication links 208) according to the IEEE 802.11 family of wireless communication protocol standards (such as that defined by the IEEE 802.11-2016 specification or amendments thereof including, but not limited to, 802.11ay, 802.11ax, 802.11az, 802.11ba and 802.11be). These standards define the WLAN radio and baseband protocols for the PHY and medium access control (MAC) layers. The APs 202 and STAs 204 transmit and receive wireless communications (hereinafter also referred to as “Wi-Fi communications”) to and from one another in the form of PHY protocol data units (PPDUs) (or physical layer convergence protocol (PLCP) PDUs). The APs 202 and STAs 204 in the WLAN 200 may transmit PPDUs over an unlicensed spectrum, which may be a portion of spectrum that includes frequency bands traditionally used by Wi-Fi technology, such as the 2.4 GHz band, the 5 GHz band, the 60 GHz band, the 3.6 GHz band, and the 900 MHz band. Some implementations of the APs 202 and STAs 204 described herein also may communicate in other frequency bands, such as the 6 GHz band, which may support both licensed and unlicensed communications. The APs 202 and STAs 204 also can be configured to communicate over other frequency bands such as shared licensed frequency bands, where multiple operators may have a license to operate in the same or overlapping frequency band or bands.

Each of the frequency bands may include multiple sub-bands or frequency channels. For example, PPDUs conforming to the IEEE 802.11n, 802.11ac, 802.11ax, and 802.11be standard amendments may be transmitted over the 2.4, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, or 320 MHz by bonding together multiple 20 MHz channels.

Each PPDU is a composite structure that includes a PHY preamble and a payload in the form of a PHY service data unit (PSDU). The information provided in the preamble may be used by a receiving device to decode the subsequent data in the PSDU. In instances in which PPDUs are transmitted over a bonded channel, the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control, and channel estimation, among other uses. The legacy preamble also may generally be used to maintain compatibility with legacy devices. The format of, coding of, and information provided in the non-legacy portion of the preamble is based on the particular IEEE 802.11 protocol to be used to transmit the payload.

As noted above, an IEEE 802.11 communication network (e.g., wireless communication network 200 of FIG. 2) can implement passive TBR to allow PSTA to determine its location without transmitting any signals. Passive TBR involves a series of ranging exchanges between one or more responding STA (RSTAs) and a set of initiating STAs (ISTAs). A PSTA may operate in a passive mode, merely receiving and processing signals without actively transmitting to estimate its differential distance to pairs of RSTAs and ISTAs. By performing measurements the DToA of signals transmitted between the RSTAs and ISTAs, the PSTA (or another device using the measurements) can accurately determine the location of the PSTA.

As discussed below, the RSTA may correspond to a base station (e.g., base station 120 of FIG. 1), and AP (e.g., AP 130 of FIG. 1 and/or AP 202 of FIG. 2), or mobile electronic device (e.g., mobile device 105 or other mobile devices 145 of FIG. 1, and/or STAs 204 of FIG. 2). The ISTA and PSTA may correspond to a mobile device (e.g., mobile device 105 and/or other mobile devices 145 of FIG. 1, or STAs 204 of FIG. 2), a client device, an AP, or any device with an RF radio. This may include, for example, a Wi-Fi radio, ultra-wideband (UWB) radio, cellular radio, and/or other types of radios or transceivers.

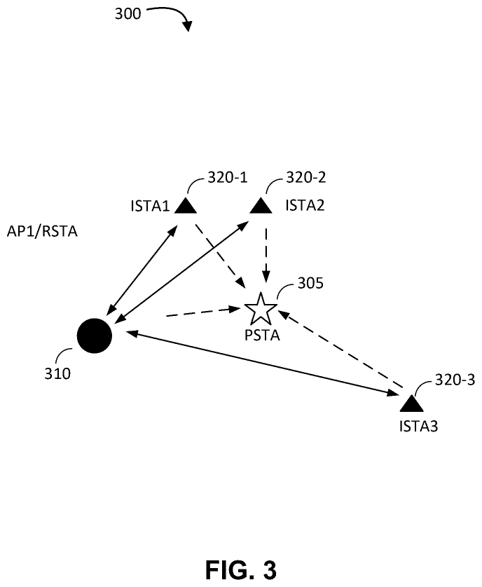

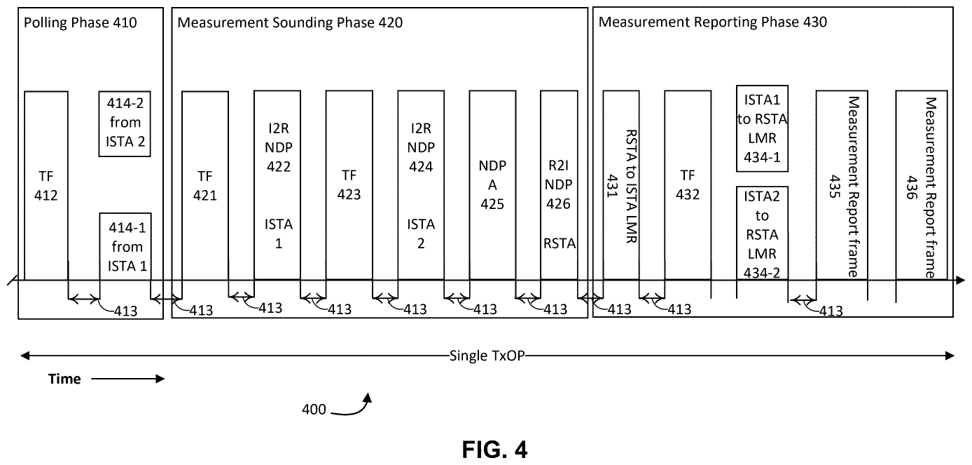

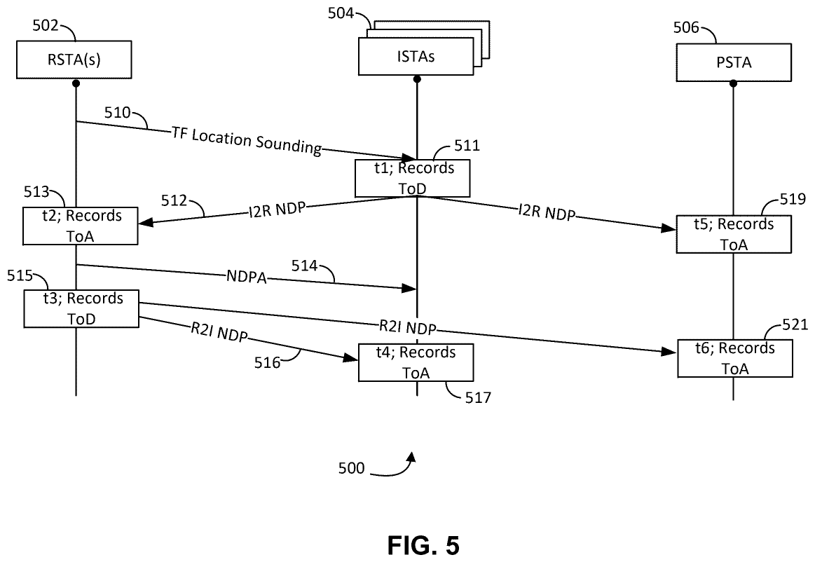

For example, FIG. 3 illustrates an example environment 300 in which passive TBR for a PSTA may be performed, FIG. 4 is a diagram showing an example of a radio frame sequence 400 with passive TBR between RSTA(s) and ISTAs, and FIG. 5 is a timing diagram 500 showing an example passive TBR measurement exchange for passive ranging a PSTA. It is appreciated that FIGS. 3, 4, and 5 may be considered together for a comprehensive understanding of the passive ranging process. Of course, the example scenarios illustrated in FIGS. 3-5 are provided as nonlimiting examples. Different scenarios may include a different configuration and/or number of STAs, which may include a plurality of PSTAs.

As shown in FIG. 3, a PSTA 305 may determine location information indicative if its location (e.g., a location estimate and/or location measurement(s)) based on communications between an RSTA 310, and three ISTAs 320 (ISTA1, ISTA2, ISTA3). Specifically, an access point (AP) with a known location may function as the RSTA 310, which operates within a specific availability window dedicated to passive TBR and conducts ranging exchanges with multiple ISTAs 320 (the radio frame sequence and the timing diagram will be discussed in detail below along with FIGS. 4 and 5 respectively). When performing the passive TBR, the PSTA 305 may listen passively to the ranging exchange between the RSTA 310 and each ISTA of the ISTAs 320. The PSTA 305 may intercept transmissions from ongoing passive TBR exchanges between the RSTA 310 and the ISTAs 320. By receiving these transmissions, the PSTA 305 may perform measurements indicative of its differential distance relative to each RSTA-ISTA pair, and the measurements may be used to determine a precise location estimate for the PSTA 305.

As shown in FIG. 4, the radio frame sequence 400 may start with the polling phase 410 where the RSTA initiates the ranging process by sending a Trigger Frame (TF) 412 for the purpose of location polling. In TF 412, uplink resources are allocated to individual ISTAs. The ISTAs respond with Clear to Send (CTS)-to-self (CST2SELF) frames 414 to acknowledge the polling and reserve the medium for the subsequent ranging process. For example, the first CST2SELF 414-1 from ISTA1 and the CTS-to-self frame 414-2 from ISTA2, following immediately after the TF with a Short Interframe Space (SIFS) interval 413, may be transmitted. It can be noted that although only two ISTAs participate in the communication illustrated in FIG. 4, this process may be expanded to any number of ISTAs, depending on the number of ISTAs available for TBR.

After the polling phase 410, following another SIFS interval, in a measurement sounding phase 420, the RSTA transmits a Passive Location Subvariant Ranging Trigger frame 421 to ISTA 1. The trigger frame 421 may be addressed to individual ISTAs. The ISTA 1 responds by transmitting a High Efficiency (HE) Ranging Null Data Packet (NDP) 422 after another SIFS interval. The RSTA then repeats the process for ISTA 2 by sending another trigger frame 423 after a SIFS interval. ISTA 2 also responds by sending its HE Ranging NDP 424 after another SIFS interval. The RSTA then announces the upcoming NDP transmission by sending an NDP announcement frame 425. This ensures that all participating stations are aware of the forthcoming NDP. The RSTA then sends its HE Ranging NDP 426, completing the measurement sounding phase 420.

At measurement Reporting Phase 430, the RSTA sends Location Measurement Reports (LMRs) in frame 431 to the ISTAs. These reports contain the timing measurements and other relevant data collected during the measurement sounding phase 420. The RSTA then sends another trigger frame 432 to request LMRs from the ISTAs. ISTA 1 and ISTA 2 then send their LMRs during the frame 434 back to the RSTA. The RSTA then broadcasts a location measurement report during frame 435, summarizing the data collected from the ISTAs. In some implementations, if another RSTA takes on a secondary role, it also broadcasts its measurement report during frame 436, adding further data for enhanced location accuracy.

FIG. 5 shows the timing diagram 500 of an example passive TBR measurement exchange for passive ranging a PSTA 506. As shown in FIG. 5, the passive trigger-based ranging for the PSTA 506 may be performed between RSTA(s) 502, ISTAs 504, and the PSTA 506 in a passive TBR measurement exchange.

Starting at arrow 510, the RSTA(s) 502 send a TF for location sounding to the ISTAs 504. At timestamp t1, in block 511, the ISTAs 504 record the Time of Departure (ToD) when they send the Initiator to Responder Null Data Packet (I2R NDP). At arrow 512, the ISTAs 504 transmit the I2R NDP to the RSTA(s) 502. At timestamp t2, in block 513, the RSTA(s) 502 record the Time of Arrival (ToA) when they receive the I2R NDP.

At arrow 514, the RSTA(s) 502 send(s) Null Data Packet Announcement (NDPA) to inform about the upcoming NDP transmission. At arrow 516, the RSTA(s) 502 transmit the R2I NDP (Responder to Initiator Null Data Packet) to the ISTAs 504. At timestamp t3, in block 515, the RSTA(s) 502 record the ToD when they send the R2I NDP. At timestamp t4, in block 517, the ISTAs 504 record the ToA when they receive the R2I NDP.

On the PSTA 506's side, the PSTA 506 passively listens to the exchanges between the RSTA(s) 502 and the ISTAs 504 and records the following timestamps: at timestamp t5, in block 519, the PSTA 506 records the ToA when it obtains the I2R NDP. At timestamp t6, at block 521, the PSTA 506 records the ToA when it obtains the R2I NDP.

In some implementations, the PSTA 506 may use the ISTAs 504's and RSTA(s) 502's timestamps, together with its own measured ToAs of the ranging NDPs (t5 and t6), to calculate its differential time of flight to the RSTA(s) 502 and the ISTAs 504. The differential time of flight from the PSTA 506 to the RSTA(s) 502 and the ISTAs 504, DToF_PRI, can be defined according to Eqn. 1:

DToF_PRI=ToF_PR−ToF_PI (Eqn. 1)

where ToF_PR denotes the ToF between the PSTA 506 and the RSTA(s) 502, and ToF_PI denotes the time of flight between the PSTA 506 and the ISTAs 504.

The differential time of flight DToF_PRI can be calculated according to Eqn. 2:

DToF_PRI=t6−t5−0.5×t3′+0.5×t2′−0.5×t4′+0.5×t1′ (Eqn. 2)

where t1′ and t4′ denote the times at which the I2R NDP was transmitted from the ISTAs 504 and the time at which the R2I NDP was received by the ISTAs 504, respectively, converted by the PSTA 506 from the ISTAs 504's time basis to the PSTA 506's time basis. Similarly, t2′ and t3′ denote the times at which the I2R NDP was received by the ISTAs 504 and the time at which the R2I NDP was transmitted by the RSTA(s) 502, respectively, converted by the PSTA 506 from the RSTA(s) 502's time basis to the PSTA 506's time basis.

At the PSTA 506, the mechanism by which t1′ and t4′ are derived from t1 and t4, the ISTAs 504 reported Carrier Frequency Offset (CFO), and the PSTA 506's CFO measured with respect to the RSTA, is implementation dependent. Similarly, at the PSTA 506, the mechanism by which t2′ and t3′ are derived from t2 and t3, and the PSTA 506's CFO measured with respect to the RSTA(s) 502, is also implementation dependent. Based on the DToFs between the PSTA 506 and both the RSTA(s) 502 and ISTAs, a location estimate of the PSTA 506 can be determined using hyperbolic positioning techniques.

It is appreciated that the example passive TBR processes discussed herein are for illustrative purposes only. It will be apparent to those skilled in the art that the passive TBR may not be limited to the example discussed herein, and substantial variations may be made in accordance with specific requirements.

As previously noted, IEEE 802.11az and 802.11bk standards provide for the positioning of passive stations (PSTAs) through passive TBR, but do not provide means by which the location of PSTAs may be communicated to other STAs. This can be an impediment to groups of moving devices (e.g., on a factory floor, in the air, etc.) that may need to navigate around each other.

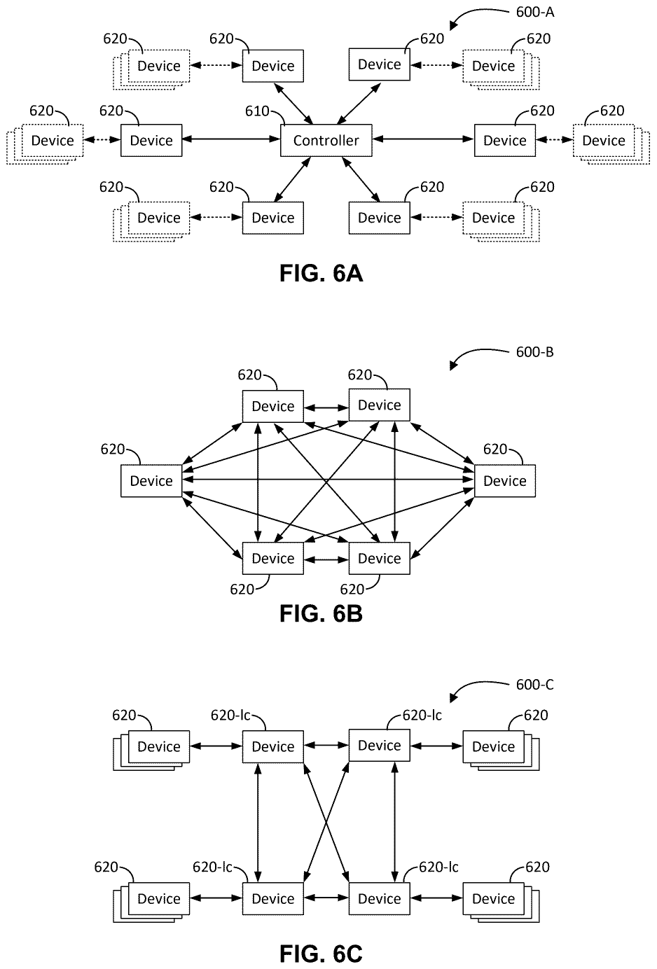

For example, a group of IoT devices moving on a factory floor may work together in coordination. This coordination may be managed by a controller, which may be chosen using a predefined selection mechanism. In a centralized device network, the controller may need to know the location of each IoT device to provide the next set of movement instructions. In a decentralized device network, each IoT device may need to monitor the motion of surrounding IoT devices and estimate their locations. In either case, determining the location of each IoT device may require the system to perform ranging with each IoT device, one at a time, which would introduce a substantial overhead that increases significantly with the number of IoT devices in the device network, leading to a considerable impact on system throughput. However, the utilization of passive TBR can significantly reduce the amount of overhead needed to determine the location of each device in a group of devices, or device network. FIGS. 6A-6C, described below, illustrate different types of device networks that may benefit from the use of passive TBR for the positioning of devices.

FIG. 6A is an illustration of an example centralized network 600-A, according to an embodiment. In this example, the centralized network 600-A has a single controller 610 communicatively coupled with multiple devices 620. In a device network implementing passive TBR, the controller 610 may correspond with an RSTA, and devices 620 may correspond with ISTAs and PSTAs. Alternatively, ISTAs and PSTAs may communicate with a single RSTA, which may relay information such as location reporting to a controller (not shown). Depending on implementation, the various devices 620 may be mobile and/or stationary devices, and the controller 610 itself may be mobile or stationary. Because the controller has location information for all the devices 620 in the centralized network 600-A, it can determine navigation maneuvers for each device 620 to help minimize or prevent collision between devices 620.

In the illustration of FIG. 6A, optional devices and communication pathways (arrows) are shown by dotted lines. These optional devices show a variation in which the centralized network is “cascaded,” such that the controller communicates directly with a subgroup of devices, and each of these devices communicates with a respective group of devices. Such cascading can be common in large device networks. Very large networks may implement further layers of cascading (not shown). In cascaded networks, communication between a subgroup and its local controller may be similar to a centralized network and its controller, as described herein.

FIG. 6B is an illustration of an example decentralized network 600-B. In a decentralized network 600-B, each device 620 communicates with each other device 620 in the network. Because there is no central controller, each device 620, if mobile, may need to determine its own navigation to try to minimize collisions with other devices 620. As such, it may need to know the location of at least the nearest devices 620 with which a collision may be possible. Thus, in a decentralized network, more processing may be needed at each device 620 to track the location and movement of nearby devices 620 and determine its own navigation maneuvers.

FIG. 6C is an illustration of an example hybrid network 600-C. The hybrid network 600-C is a hybrid between a centralized network 600-A and decentralized network 600-B. It includes aspects of a centralized network because groups of devices 620 report to a respective local controlling device 620-lc. It also includes aspects of a decentralized network because the local controlling devices 620-lc communicate with each other. In this way, the location of all devices 620 in the hybrid network 600-C may be collectively tracked by the local controlling devices 620-lc, but no single device functions as a controller for the entire hybrid network 600-C. Similar to cascading in a centralized network, additional groups of devices 620 and respective local controlling devices 620-lc can be added to the hybrid network 600-C, allowing for scalability.

Utilizing passive TBR can significantly reduce the amount of overhead needed to determine the location of each device in a device network, such as the networks illustrated in FIGS. 6A-6C. As previously described, passive TBR can be conducted such that only a few devices (e.g., at least one RSTA and a plurality of ISTAs) transmit signals. These signals may be used by any number of PSTAs in the device network to determine their respective locations. However, as also previously noted, passive TBR does not have a mechanism by which PSTAs can report their position (either to a controller in a centralized network or other devices in a decentralized network). Accordingly, passive TBR has no native feature that can benefit networks of moving devices to help minimize collisions between devices.

To address these and other issues, embodiments herein define new PSTA collection and reporting frames that can be used with passive TBR (and/or other positioning techniques) to gather and communicate PSTA location reports. This can be particularly useful in networks of devices in which the location of each device may need to be tracked in order to help prevent physical collisions of devices.

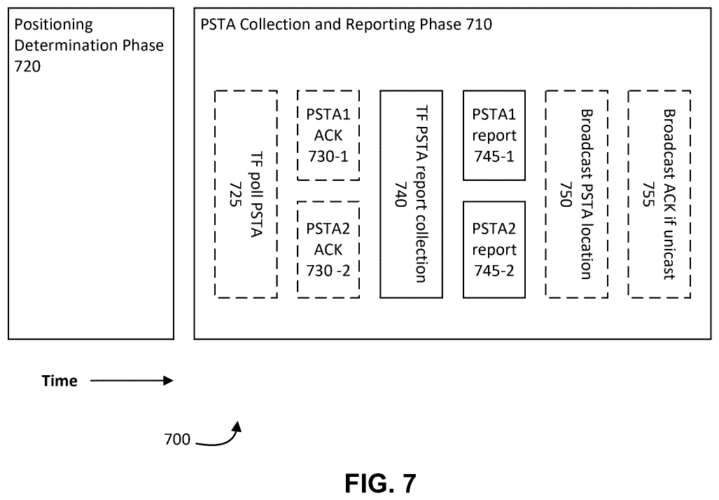

FIG. 7 is a diagram of a radio frame sequence 700, illustrating new frames that may be utilized in accordance with embodiments herein as part of a PSTA collection and reporting phase 710. This may be used in an 802.11 wireless network subsequent to a positioning determination phase 720, for example. The positioning determination phase 720 may comprise a phase during which various PSTAs determine their respective locations, such as passive TBR, such that the various PSTAs are ready to report their respective locations during the PSTA collection and reporting phase 710. Therefore, according to some embodiments, the PSTA collection and reporting phase 710 may follow a passive TBR radio frame sequence such as the one illustrated in FIG. 4. As explained in more detail hereafter, radio frames illustrated with dashed lines may be optional, depending on desired functionality.

The various frames of the PSTA collection and reporting phase 710 are as follows. Initially, an RSTA May send a poll trigger frame (TF) 725 to solicit responses from all PSTAs available to provide location reports. PSTAs may then respond to the poll TF 725 with acknowledgment frames 730 (e.g., PSTA ACKs 730-1 and 730-2). (It can be noted that the two acknowledgments are illustrated in FIG. 7 are provided for illustrative purposes. There may be any number of acknowledgments, depending on the number of PSTAs responding to the poll TF 725.) As with acknowledgments provided in FIG. 4, the acknowledgment frames 730 by the PSTAs may be performed using CST2SELF. The RSTA may then transmit a PSTA report collection TF 740 to solicit reports from the PSTAs that responded to the poll TF 725, in the PSTAs respond by providing location report frames 745, comprising location information determined during the positioning determination phase 720. This location information can include a respective estimated location determined by each PSTA and/or one or more location measurements (e.g., ranging measurements) performed during the positioning determination phase 720, such as differential time of arrival. These location report frames 745 are collected by the RSTA, which may then broadcast the PSTA location frame 750. The PSTA location frame may include (1) the locations of all the PSTAs (e.g., the estimated locations of the PSTAs as received by the RSTA, and/or estimated locations as determined by the RSTA from location measurements received from the PSTAs), and/or (2) the location information received by the RSTA (e.g., the respective estimated location and/or the respective one or more location measurements received by the RSTA from each PSTA). In a decentralized network, each PSTA may then receive the broadcast and, if applicable, determine a navigation route accordingly based on the locations of the various other PSTAs. In a centralized network, the PSTA location information frame 750 may be a directed broadcast (unicast) from the RSTA to a controller, which may then provide an acknowledgment frame 755. (More generally, any device to which the PSTA location information frame 750 is directed may provide an acknowledgment frame 755.) As described in the additional scenarios provided below, if the RSTA itself performs the functionality of a controller, then the RSTA may not transmit either of frames 750 or 755.

It can be noted that the timing of the location reporting performed in the PSTA collection and reporting phase 710 may vary, depending on desired functionality. For example, similar to delayed LMR feedback in 802.11az and 802.11bk, the broadcast PSTA location frame 750 can be delayed and sent as part of the next PSTA collection and report. That is, for positions determined during time period n, these positions may be broadcast in a frame during a PSTA collection and reporting phase 710 performed during time period n+1.

The content of the various reports and broadcasts may include information as prescribed in relevant standards documents. That is, in the various PSTA location reports collected in PSTA location report frames 745, the PSTAs can include location information similar to location reporting used by other devices as described in the 802.11az and 802.11bk standards (e.g., similar to reporting performed in measurement reporting phase 430 of FIG. 4, described above). Further, the PSTA location information frame 750 may include the various PSTA a location reports collected in PSTA location report frames 745, or a summary or compressed version thereof. (In some embodiments, for example, such a broadcast may only include location information for devices that have moved since a previous broadcast.)

According to some embodiments, the frames transmitted in the PSTAs collection and reporting phase 710 may be transmitted in a secure manner. That is, the PSTA collection and reporting phase 710 may be encrypted such that only devices with the encryption key (e.g., authorized devices in a device network) can decode broadcast information. (This encryption key may be transmitted, for example, using a secure communication connection.) According to some embodiments, security measures may include MAC only security, in which transmitted data is encrypted at MAC layer, and only devices with a key are able to decode it. According to some embodiments, additional or alternative security measures may be used, such as physical layer (PHY) together with MAC layer security.

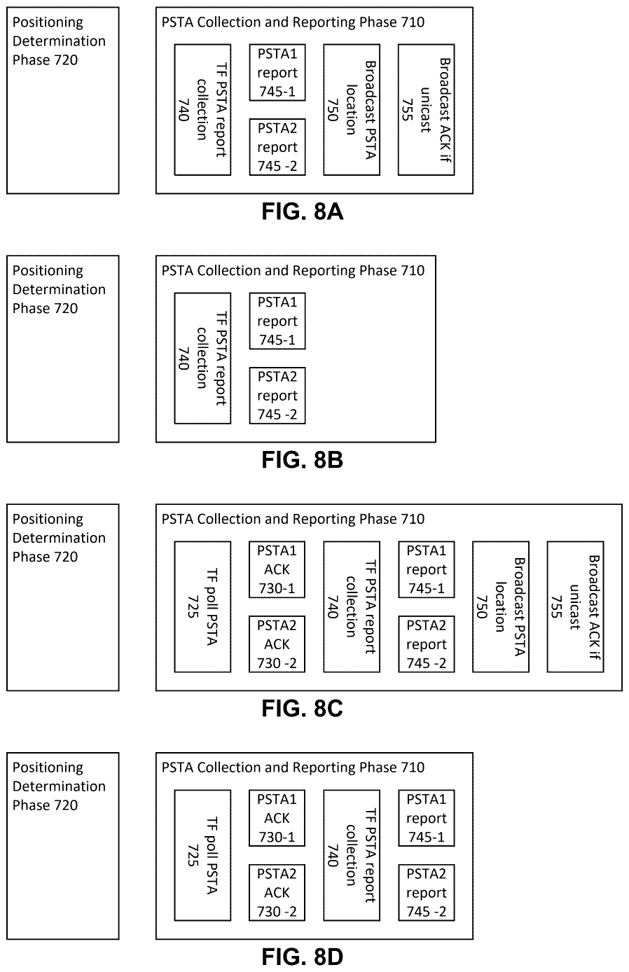

Again, different subsets of the frames used in the PSTA collection and reporting phase 710 may accommodate the different needs of various scenarios. Specific subsets are illustrated in the radio frame sequence diagrams of FIGS. 8A-8D, described below.

FIG. 8A illustrates a PSTA collection and reporting phase 710 with a first subset of frames. Here, available PSTAs are known by the RSTA, and thus, the RSTA does not need to send an initial TF poll. Instead, the RSTA may simply transmit a TF PSTA report collection frame 740. The subsequent frames may then proceed as indicated: pieces can send acknowledgment frames 745, the RSTA may then broadcast the PSTA location frame 750 (e.g., in a directed broadcast to a controller), and receiving device(s) (e.g., the controller) can provide an acknowledgment frame 755.

FIG. 8B illustrates a PSTA collection and reporting phase 710 with a second subset of frames. The frames in this example may represent a basic set of frames for PSTA collection and reporting. Similar to the example of FIG. 8A, available PSTAs are known by the RSTA, so the RSTA transmits the PSTA report collection frame 740 with no TF poll frame, and the responding PSTAs provide acknowledgment frames 745. In contrast with the example of FIG. 8A, however, the example of FIG. 8B does not include frames 750 or 755. As previously noted, in cases in which the RSTA is the consumer of the information, there may be no need for the RSTA to broadcast the collected location information of the various PSTAs. If the RSTA is the controller for a centralized device network, for example, the RSTA can determine navigation paths for the various PSTAs and send corresponding navigation instructions (not shown) to the PSTAs.

FIG. 8C illustrates a PSTA collection and reporting phase 710 with the full set of frames illustrated in FIG. 7 and described above. Embodiments may use this full set of frames, for example, when the PSTAs that can provide location reports are unknown. In this case, the RSTA can rely on the poll TF 725 to decide which PSTA locations to collect. The PSTA report collection TF 740 may then include only PSTAs that respond to the poll TF 725 with location report frames 745.

FIG. 8D illustrates a PSTA collection and reporting phase 710 with yet another subset of frames. Here, the poll TF 725, PSTA acknowledgment frames 730, PSTA report collection TF 740, and PSTA location report frames 745 are used in a manner similar to the example of FIG. 8C, described above. In contrast with the example in FIG. 8C, for example, the RSTA a in the example of FIG. 8D is the consumer of information. Thus, similar to the example of FIG. 8B, there is no need to include additional broadcast frames 750 or 755.

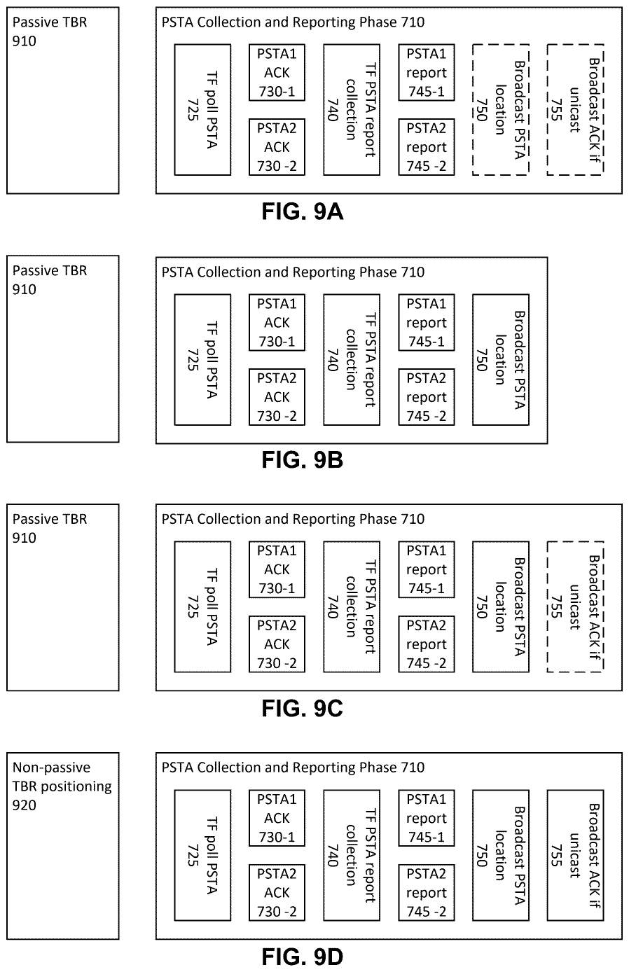

FIGS. 9A-9D are radio frame sequence diagrams, similar to those illustrated in FIG. 7 and FIGS. 8A-8D. The diagrams illustrate particular subsets of the frames used in the PSTA collection and reporting phase 710 that may be used in specific scenarios described below.

FIG. 9A is a radio frame sequence used in a first scenario in which a network of autonomous moving devices includes a centralized controller, and at any given instance all devices are in motion. In the first scenario, passive TBR 910 is first performed (e.g., as described above with respect to FIG. 4). The selection of which RSTA(s) and ISTAs may be determined based on implementation preferences, and other devices in the device network may operate as RSTAs to passively determine their respective locations. (For accuracy, RSTA(s) and ISTAs may be selected based on factors such as movement, device capability, and so forth.) The subset of frames used in the PSTA collection and reporting phase 710 may reflect the subset illustrated in FIG. 8D if the RSTA is the consumer of the location information (e.g., controller) for all PSTAs. Otherwise, the subset of frames used in the PSTA collection and reporting phase 710 may reflect the subset illustrated in FIG. 8C, in which the RSTA unicasts location report information to a controller ((directed) broadcast PSTA location information frame 750), which then provides an acknowledgment (acknowledgment frame 755). In either case, the RSTA or controller may subsequently transmit movement instructions (not shown) to the various devices in the network to give movement directions or otherwise facilitate the movement of the various devices.

FIG. 9B is a radio frame sequence used in a second scenario in which a network of autonomous moving devices is decentralized, and, at any given instance, all devices may be in motion. Similar to the first scenario illustrated in FIG. 9A, this scenario includes an initial positioning operation that includes passive TBR 400. In this scenario, and again similar to the first scenario of FIG. 9A, the RSTA may send a reporting poll to the PSTAs (poll TF 725), collect subsequent acknowledgments (acknowledgment frames 730), send a report collection trigger frame (PSTA report collection TF 740), and collect corresponding reports from the various reporting PSTAs (location report frames 745). Because the device network in this second scenario is decentralized, the RSTA can then broadcast the location information collected from the PSTA location reports (location report frames 745) using a broadcast frame (PSTA location information frame 750). Each device and the device network may then use the broadcasted location information to determine a respective navigation route to its next position, based at least in part on its location and the location of one or more other devices (e.g., nearby devices) in the device network.

FIG. 9C is a radio frame sequence used in a third scenario in which a network of autonomous moving devices is centralized or decentralized, and, at any given instance, not all devices are in motion. Similar to the first and second scenarios illustrated in FIGS. 9A and 9B, this scenario includes an initial positioning operation that includes passive TBR 400. In this scenario, as with the first and second scenarios described above, the RSTA may send a reporting poll to the PSTAs (poll TF 725), collect subsequent acknowledgments (acknowledgment frames 730), send a report collection trigger frame (PSTA report collection TF 740), and collect corresponding reports from the various reporting PSTAs (location report frames 745). Here, however, because not all devices are in motion, and not all devices may respond to the poll TF 725, and thus, not all devices may provide PSTA location report frames 745. In a centralized device network, the RSTA (or controller, if separate from the RSTA) may send a directed poll TF 725 only to trigger PSTAs that are in motion (e.g., have moved since a previous time and/or are expected to move by a future time), according to some embodiments. In a decentralized device network, only PSTAs that are in motion (e.g., have moved since a previous time and/or are expected to move by a future time) may respond to the poll TF 725, according to some embodiments. The RSTA may then broadcast the location information of the PSTAs using broadcast PSTA location information frame 750. In a decentralized device network, this may be a pure broadcast. In a centralized device network, this broadcast may be directed (e.g., unicast or multicast) to one or more controllers of the device network. If unicast (or multicast), the receiving device(s) may provide an acknowledgment (acknowledgment frame 755).

Although similar to the scenarios of FIGS. 9A and 9B, the third scenario of FIG. 9C has some differences. In particular, not all devices are in motion. Thus, the RSTA(s) and ISTAs may be different because they may be selected based, at least in part, on motion. (According to some embodiments, it may be preferable to use nonmoving or stationary devices as the RSTA(s) and ISTAs. This can help increase the accuracy of resulting position determinations of the various devices in the device network.) An additional difference between the third scenario and the first and second scenarios may be that, as noted above, the third scenario may limit the PSTA collection and reporting phase 710 to only STAs that are expected to be in motion (e.g., have moved since a previous time and/or are expected to move by a future time).

FIG. 9D is a radio frame sequence used in a fourth scenario. As can be seen, the frames and the PSTA collection and reporting phase 710 may be similar to those in the first scenario of FIG. 9A and third scenario of FIG. 9C. Devices in the device network may be in motion, or not all in motion, and this may be used by a centralized, decentralized, or hybrid network. However, in the fourth scenario of FIG. 9D, one or more devices in the device network (which may include all devices) use non-passive TBR positioning 920. That is, devices in the device network may use alternative means for determining their respective positions This may include, for example, GNSS-based positioning, radio network-based positioning (e.g., radio access technology (RAT)-based positioning), and other forms of it positioning used in 802.11/Wi-Fi.

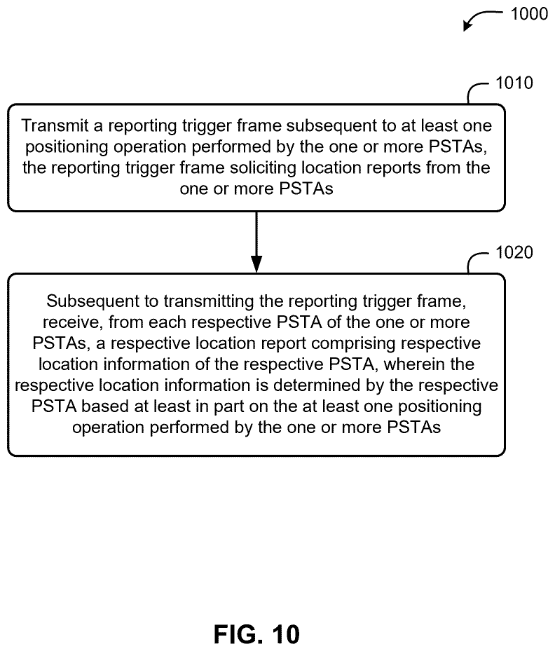

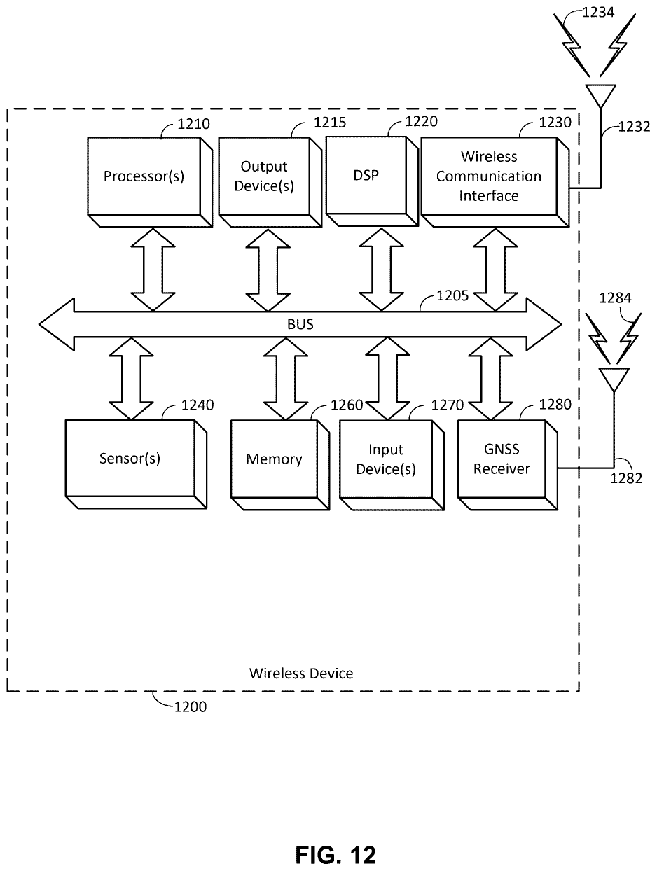

FIG. 10 is a flow diagram of a method 1000 performed by an RSTA of collecting location reports from one or more PSTAs, according to an embodiment. Aspects of the method 1000 may reflect various functions of an RSTA described in the embodiments described above. Means and/or structure for performing the functionality illustrated in one or more of the blocks shown in FIG. 10 may be performed by hardware and/or software components of a wireless device. Example components of a wireless device 1200 are illustrated in FIG. 12, which is described in more detail below.

At block 1010, the functionality comprises transmitting a reporting trigger frame subsequent to at least one positioning operation performed by the one or more PSTAs, the reporting trigger frame soliciting location reports from the one or more PSTAs. This reporting trigger frame may correspond with frame 740 of FIGS. 7-9D, for example. As noted in the embodiments described above, the type of positioning operation(s) performed may vary. According to some embodiments, the at least one positioning operation comprises a TBR operation. According to some embodiments, the at least one positioning operation comprises a non-TBR operation, such as a GNSS-based positioning operation, a radio network-based positioning operation, a Wi-Fi-based positioning operation, or any combination thereof.

Means for performing functionality at block 1010 may comprise a bus 1205, processor(s) 1210, digital signal processor(s) 1220, wireless communication interface 1230 (e.g., transceiver(s)), memory(ies) 1260, and/or other components of a wireless device 1200, as illustrated in FIG. 12.

At block 1020, the functionality comprises, subsequent to transmitting the reporting trigger frame, receiving, from each respective PSTA of the one or more PSTAs, a respective location report comprising respective location information of the respective PSTA, wherein the respective location information is determined by the respective PSTA based at least in part on the at least one positioning operation performed by the one or more PSTAs. The location report(s) may correspond with frames 745 of FIGS. 7-9D, for example. As noted, the location reports may include location estimate(s) of the PSTA(s) and/or one or more measurements that may be used to determine location estimate(s) of the PSTA(s). As such, according to some embodiments, for each respective PSTA of the one or more PSTAs, the respective location information may comprise a location estimate of the respective PSTA, a location measurement performed by the PSTA, or a combination thereof.

Means for performing functionality at block 1020 may comprise a bus 1205, processor(s) 1210, digital signal processor(s) 1220, wireless communication interface 1230 (e.g., transceiver(s)), memory(ies)1260, and/or other components of a wireless device 1200, as illustrated in FIG. 12.

Depending on desired functionality, embodiments may include one or more additional features, as described herein. For example, some embodiments may further comprise transmitting one or more location messages indicative of the respective location information received from each respective PSTA of the one or more PSTAs. The one or more location messages may correspond to the PSTA location frame 750 described in the embodiments above. According to some embodiments, the RSTA and the one or more PSTAs may be part of a decentralized device network. Alternatively, the RSTA and one or more PSTAs may be part of a centralized device network having a controller separate from the RSTA, the method further comprising receiving, from the controller, an acknowledgement of receiving the one or more location messages. According to some embodiments, the RSTA may operate as a controller for a device network comprising the RSTA and the one or more PSTAs. Some embodiments may further comprise, prior to transmitting the reporting trigger frame, transmitting a polling trigger frame to identify the one or more PSTAs providing the location reports, and receiving a respective poll acknowledgement from each PSTA of the one or more PSTAs.

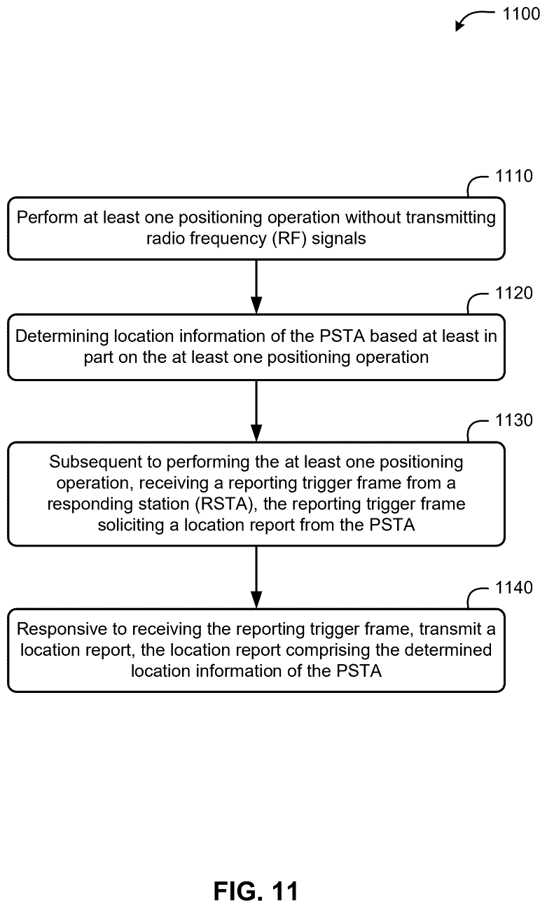

FIG. 11 is a flow diagram of a method 1100 of reporting location-related information performed by a PSTA, according to an embodiment. Aspects of the method 1100 may reflect various functions of an PSTA described in the embodiments described above. Means and/or structure for performing the functionality illustrated in one or more of the blocks shown in FIG. 11 may be performed by hardware and/or software components of a wireless device. Example components of a wireless device 1200 are illustrated in FIG. 12, which is described in more detail below.

At block 1110, the functionality comprises performing at least one positioning operation without transmitting radio frequency (RF) signals. This may correspond with blocks 720, 910, and/or 920 of FIGS. 7-9D, for example. As noted previously, this may comprise any of a variety of passive positioning operations (e.g., GNSS-based, RAT-based, etc.). According to some embodiments, the at least one positioning operation comprises a TBR operation. According to some embodiments, the at least one positioning operation comprises a non-TBR operation.

Means for performing functionality at block 1110 may comprise a bus 1205, processor(s) 1210, digital signal processor(s) 1220, wireless communication interface 1230 (e.g., transceiver(s)), sensor(s) 1240, memory(ies)1260, GNSS receiver(s) 1280, and/or other components of a wireless device 1200, as illustrated in FIG. 12.

At block 1120, the functionality comprises determining location information of the PSTA based at least in part on the at least one positioning operation. This functionality may vary, depending on the type(s) of positioning operation(s) performed. Moreover, if multiple positioning operations are performed, a position may be determined via fusion, weighting, and/or other techniques for combining results of the multiple positioning operations.

Means for performing functionality at block 1120 may comprise a bus 1205, processor(s) 1210, digital signal processor(s) 1220, memory(ies)1260, GNSS receiver(s) 1280, and/or other components of a wireless device 1200, as illustrated in FIG. 12.

At block 1130, the functionality comprises, subsequent to performing the at least one positioning operation, receiving a reporting trigger frame from a responding station (RSTA), the reporting trigger frame soliciting a location report from the PSTA. As previously noted, the reporting trigger frame may correspond to frame 740 of FIGS. 7-9D, for example.

Means for performing functionality at block 1130 may comprise a bus 1205, processor(s) 1210, digital signal processor(s) 1220, wireless communication interface 1230 (e.g., transceiver(s)), sensor(s) 1240, memory(ies)1260, GNSS receiver(s) 1280, and/or other components of a wireless device 1200, as illustrated in FIG. 12.

At block 1140, the functionality comprises, responsive to receiving the reporting trigger frame, transmitting a location report, the location report comprising the determined location information of the PSTA. As previously noted, this functionality may correspond with frame 745 of FIGS. 7-9D, for example. Additionally, or alternatively, the PSTA may transmit the location report responsive to being preconfigured to do so subsequent to performing one or more positioning operations and may not depend on a triggering frame to do so.

Means for performing functionality at block 1140 may comprise a bus 1205, processor(s) 1210, digital signal processor(s) 1220, wireless communication interface 1230 (e.g., transceiver(s)), sensor(s) 1240, memory(ies)1260, GNSS receiver(s) 1280, and/or other components of a wireless device 1200, as illustrated in FIG. 12.

Depending on desired functionality, embodiments may include one or more additional features, as described herein. For example, some embodiments may further comprise, subsequent to transmitting the location report, receiving one or more location messages from the RSTA, the one or more location messages indicative of a respective location of each of one or more additional PSTAs. The one or more location messages may correspond to the PSTA location frame 750 described in the embodiments above. According to some embodiments, the PSTA and the RSTA may be part of a decentralized device network. According to some embodiments, the PSTA and the RSTA may be part of a centralized device network having a controller separate from the RSTA. According to some embodiments, RSTA may operate as a controller for a device network comprising the PSTA and the RSTA. Some embodiments may further comprise, prior to receiving the reporting trigger frame receiving a polling trigger frame from the RSTA, and responsive to receiving the polling trigger frame, transmitting a poll acknowledgement.

FIG. 12 is a block diagram of an embodiment of a wireless device 1200, which can be utilized as described herein above (e.g., in association with FIGS. 1-11). For example, the wireless device 1200 may comprise a mobile device, AP, and/or STA (e.g., ISTA, RSTA, and/or PSTA) as described herein, and can perform one or more of the functions of the method1 shown in FIGS. 10 and 11. It should be noted that FIG. 12 is meant only to provide a generalized illustration of various components, any or all of which may be utilized as appropriate. It can be noted that, in some instances, components illustrated by FIG. 12 can be localized to a single physical device and/or distributed among various networked devices, which may be disposed at different physical locations. Furthermore, as previously noted, the functionality of the UE discussed in the previously described embodiments may be executed by one or more of the hardware and/or software components illustrated in FIG. 12.

The wireless device 1200 is shown comprising hardware elements that can be electrically coupled via a bus 1205 (or may otherwise be in communication, as appropriate). The hardware elements may include a processor(s) 1210 which can include without limitation one or more general-purpose processors (e.g., an application processor), one or more special-purpose processors (such as digital signal processor (DSP) chips, graphics acceleration processors, application specific integrated circuits (ASICs), and/or the like), and/or other processing structures or means. Processor(s) 1210 may comprise one or more processing units, which may be housed in a single integrated circuit (IC) or multiple ICs. As shown in FIG. 12, some embodiments may have a separate DSP 1220, depending on desired functionality. Location determination and/or other determinations based on wireless communication may be provided in the processor(s) 1210 and/or wireless communication interface 1230 (discussed below). The wireless device 1200 also can include one or more input devices 1270, which can include without limitation one or more keyboards, touch screens, touch pads, microphones, buttons, dials, switches, and/or the like; and one or more output devices 1215, which can include without limitation one or more displays (e.g., touch screens), light emitting diodes (LEDs), speakers, and/or the like.

The wireless device 1200 may also include a wireless communication interface 1230, which may comprise without limitation a modem, a network card, an infrared communication device, a wireless communication device, and/or a chipset (such as a Bluetooth® device, an IEEE 802.11 device (e.g., implementing) 802.11az and/or 802.11bk standards), an IEEE 802.15.4 device, a WiMAX device, a WAN device, and/or various cellular devices, etc.), and/or the like, which may enable the wireless device 1200 to communicate with other devices as described in the embodiments above. The wireless communication interface 1230 may permit data and signaling to be communicated (e.g., transmitted and received) with wireless nodes of a communication network, for example, via eNBs, gNBs, ng-eNBs, access points, various base stations, and/or other access node types, and/or other network components, computer systems, and/or any other electronic devices, as described herein. The communication can be carried out via one or more wireless communication antenna(s) 1232 that send and/or receive wireless signals 1234. According to some embodiments, the wireless communication antenna(s) 1232 may comprise a plurality of discrete antennas, antenna arrays, or any combination thereof. The antenna(s) 1232 may be capable of transmitting and receiving wireless signals using beams (e.g., Tx beams and Rx beams). Beam formation may be performed using digital and/or analog beam formation techniques, with respective digital and/or analog circuitry. The wireless communication interface 1230 may include such circuitry.

Depending on desired functionality, the wireless communication interface 1230 may comprise a separate receiver and transmitter, or any combination of transceivers, transmitters, and/or receivers to communicate with base stations (e.g., ng-eNBs and gNBs) and other terrestrial transceivers, such as wireless devices and access points. The wireless device 1200 may communicate with different data networks that may comprise various network types. For example, a WWAN may be a CDMA network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX (IEEE 802.16) network, and so on. A CDMA network may implement one or more RATs such as CDMA2000®, WCDMA, and so on. CDMA2000® includes IS-95, IS-2000 and/or IS-856 standards. A TDMA network may implement GSM, Digital Advanced Mobile Phone System (D-AMPS), or some other RAT. An OFDMA network may employ LTE, LTE Advanced, 5G NR, and so on. 5G NR, LTE, LTE Advanced, GSM, and WCDMA are described in documents from 3GPP. CDMA2000® is described in documents from a consortium named “3rd Generation Partnership Project 2” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The wireless device 1200 can further include sensor(s) 1240. Sensor(s) 1240 may comprise, without limitation, one or more inertial sensors and/or other sensors (e.g., accelerometer(s), gyroscope(s), camera(s), magnetometer(s), altimeter(s), microphone(s), proximity sensor(s), light sensor(s) (e.g., lidar), infrared sensor(s), RF sensor(s) (e.g., radar), barometer(s), and the like), some of which may be used to obtain position-related measurements and/or other information. In some configurations, the sensor(s) 1240 may not be co-located with the wireless device 1200, e.g., communicatively coupled (wired or wirelessly) but not disposed at the wireless device 1200.

Embodiments of the wireless device 1200 may also include a Global Navigation Satellite System (GNSS) receiver 1280 capable of receiving signals 1284 from one or more GNSS satellites using an antenna 1282 (which could be the same as antenna 1232). Positioning based on GNSS signal measurement can be utilized to complement and/or incorporate the techniques described herein. The GNSS receiver 1280 can extract a position of the wireless device 1200, using conventional techniques, from GNSS satellites of a GNSS system, such as Global Positioning System (GPS), Galileo, GLONASS, Quasi-Zenith Satellite System (QZSS) over Japan, IRNSS over India, BeiDou Navigation Satellite System (BDS) over China, and/or the like. Moreover, the GNSS receiver 1280 can be used with various augmentation systems (e.g., a Satellite Based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although GNSS receiver 1280 is illustrated in FIG. 12 as a distinct component, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processors, such as processor(s) 1210, DSP 1220, and/or a processor within the wireless communication interface 1230 (e.g., in a modem). A GNSS receiver may optionally also include a positioning engine, which can use GNSS measurements from the measurement engine to determine a position of the GNSS receiver using an Extended Kalman Filter (EKF), Weighted Least Squares (WLS), particle filter, or the like. The positioning engine may also be executed by one or more processors, such as processor(s) 1210 or DSP 1220.

The wireless device 1200 may further include and/or be in communication with a memory 1260. The memory 1260 can include, without limitation, local and/or network accessible storage, a disk drive, a drive array, an optical storage device, a solid-state storage device, such as a random access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 1260 of the wireless device 1200 also can comprise software elements (not shown in FIG. 12), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 1260 that are executable by the wireless device 1200 (and/or processor(s) 1210 or DSP 1220 within wireless device 1200). In some embodiments, then, such code and/or instructions can be used to configure and/or adapt a general-purpose computer (or other device) to perform one or more operations in accordance with the described methods.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally, or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:
Clause 1: A method performed by a responding station (RSTA) of collecting location reports from one or more passive stations (PSTAs), the method comprising: transmitting a reporting trigger frame subsequent to at least one positioning operation performed by the one or more PSTAs, the reporting trigger frame soliciting location reports from the one or more PSTAs; and subsequent to transmitting the reporting trigger frame, receiving, from each respective PSTA of the one or more PSTAs, a respective location report comprising respective location information of the respective PSTA, wherein the respective location information is determined by the respective PSTA based at least in part on the at least one positioning operation performed by the one or more PSTAs.
Clause 2: The method of clause 1, wherein the at least one positioning operation comprises a trigger-based ranging (TBR) operation.
Clause 3: The method of either of clauses 1 or 2, wherein for each respective PSTA of the one or more PSTAs, the respective location information comprises a location estimate of the respective PSTA, a location measurement performed by the PSTA, or a combination thereof.
Clause 4: The method of any one of clauses 1-3, further comprising transmitting one or more location messages indicative of the respective location information received from each respective PSTA of the one or more PSTAs.
Clause 5: The method of clause 4, wherein the RSTA and the one or more PSTAs are part of a decentralized device network.
Clause 6: The method of clause 4, wherein the RSTA and one or more PSTAs are part of a centralized device network having a controller separate from the RSTA, the method further comprising receiving, from the controller, an acknowledgement of receiving the one or more location messages.
Clause 7: The method of any one of clauses 1-6, wherein the RSTA operates as a controller for a device network comprising the RSTA and the one or more PSTAs.
Clause 8: The method of any one of clauses 1-7, further comprising, prior to transmitting the reporting trigger frame: transmitting a polling trigger frame to identify the one or more PSTAs providing the location reports; and receiving a respective poll acknowledgement from each PSTA of the one or more PSTAs.
Clause 9: The method of any one of clauses 1-8, wherein the at least one positioning operation comprises a non-TBR operation.
Clause 10: A method of reporting location-related information, performed by a passive station (PSTA), the method comprising: performing at least one positioning operation without transmitting radio frequency (RF) signals; determining location information of the PSTA based at least in part on the at least one positioning operation; subsequent to performing the at least one positioning operation, receiving a reporting trigger frame from a responding station (RSTA), the reporting trigger frame soliciting a location report from the PSTA; and responsive to receiving the reporting trigger frame, transmitting a location report, the location report comprising the determined location information of the PSTA.
Clause 11: The method of clause 10, wherein the at least one positioning operation comprises a trigger-based ranging (TBR) operation.
Clause 12: The method of either of clauses 10 or 11, further comprising, subsequent to transmitting the location report, receiving one or more location messages from the RSTA, the location information indicative of a respective location of each of one or more additional PSTAs.
Clause 13: The method of clause 12, wherein the PSTA and the RSTA are part of a decentralized device network.
Clause 14: The method of clause 12, wherein the PSTA and the RSTA are part of a centralized device network having a controller separate from the RSTA.
Clause 15: The method of any one of clauses 10-14, wherein the RSTA operates as a controller for a device network comprising the PSTA and the RSTA.
Clause 16: The method of any one of clauses 10-15, further comprising, prior to receiving the reporting trigger frame: receiving a polling trigger frame from the RSTA; and responsive to receiving the polling trigger frame, transmitting a poll acknowledgement.
Clause 17: The method of any one of clauses 10-16, wherein the at least one positioning operation comprises a non-TBR operation.
Clause 18: A responding station (RSTA) comprising: at least one transceiver; at least one memory; and at least one processor communicatively coupled with the at least one transceiver and the at least one memory, the at least one processor configured to: transmit, via the at least one transceiver, a reporting trigger frame subsequent to at least one positioning operation performed by one or more passive stations (PSTAs), the reporting trigger frame soliciting location reports from the one or more PSTAs; and subsequent to transmitting the reporting trigger frame, receiving, via the at least one transceiver, from each respective PSTA of the one or more PSTAs, a respective location report comprising respective location information of the respective PSTA, wherein the respective location information is determined by the respective PSTA based at least in part on the at least one positioning operation performed by the one or more PSTAs.
Clause 19: The RSTA of clause 18, wherein the at least one processor is further configured to transmit one or more location messages indicative of the respective location information received from each respective PSTA of the one or more PSTAs.
Clause 20: The RSTA of clause 19, wherein the RSTA and the one or more PSTAs are part of a decentralized device network.
Clause 21: The RSTA of clause 19, wherein the at least one processor is further configured to receive, via the at least one transceiver from a controller of a centralized device network of which the RSTA is a part, an acknowledgement of receiving the one or more location messages.
Clause 22: The RSTA of clause 18, wherein the RSTA operates as a controller for a device network comprising the RSTA and the one or more PSTAs.
Clause 23: The RSTA of clause 18, wherein the at least one processor is further configured to, prior to transmitting the reporting trigger frame: transmit, via the at least one transceiver, a polling trigger frame to identify the one or more PSTAs; and receive, via the at least one transceiver, a respective poll acknowledgement from each PSTA of the one or more PSTAs.
Clause 24: A passive station (PSTA) comprising: at least one transceiver; at least one memory; and at least one processor communicatively coupled with the at least one transceiver and the at least one memory, the at least one processor configured to: perform at least one positioning operation without transmitting radio frequency (RF) signals; determine location information of the PSTA based at least in part on the at least one positioning operation; subsequent to performing the at least one positioning operation, receive a reporting trigger frame, via the at least one transceiver, from a responding station (RSTA), the reporting trigger frame soliciting a location report from the PSTA; and responsive to receiving the reporting trigger frame, transmit a location report via the at least one transceiver, the location report comprising the determined location information of the PSTA.
Clause 25: The PSTA of clause 24, wherein, to determine the location information of the PSTA, the at least one processor is configured to determine a location estimate of the respective PSTA, obtain a location measurement performed by the PSTA, or perform a combination thereof.
Clause 26: The PSTA of either of clauses 24 or 25, wherein, to perform the at least one positioning operation, the at least one processor is configured to perform a global navigation satellite system (GNSS)-based positioning operation, a radio network-based positioning operation, a Wi-Fi-based positioning operation, or any combination thereof.
Clause 27: The PSTA of any one of clauses 24-26, wherein the at least one processor is further configured to, subsequent to transmitting the location report, receive one or more location messages from the RSTA, the one or more location messages indicative of a respective location of each of one or more additional PSTAs.
Clause 28: The PSTA of any one of clauses 24-27, wherein the PSTA is configured to be part of a decentralized device network.
Clause 29: The PSTA of any one of clauses 24-27, wherein the PSTA is configured to be part of a centralized device network having a controller separate from the RSTA.
Clause 30: The PSTA of any one of clauses 24-29, wherein the at least one processor is further configured to, prior to receiving the reporting trigger frame: receive a polling trigger frame, via the at least one transceiver, from the RSTA; and responsive to receiving the polling trigger frame, transmit a poll acknowledgement, via the at least one transceiver.
Clause 31: An apparatus having means for performing the method of any one of clauses 1-17.
Clause 32: A non-transitory computer-readable medium storing instructions, the instructions comprising code for performing the method of any one of clauses 1-17.

What is claimed is:

1. A method performed by a responding station (RSTA) of collecting location reports from one or more passive stations (PSTAs), the method comprising:
transmitting a reporting trigger frame subsequent to at least one positioning operation performed by the one or more PSTAs, the reporting trigger frame soliciting location reports from the one or more PSTAs; and
subsequent to transmitting the reporting trigger frame, receiving, from each respective PSTA of the one or more PSTAs, a respective location report comprising respective location information of the respective PSTA, wherein the respective location information is determined by the respective PSTA based at least in part on the at least one positioning operation performed by the one or more PSTAs.

2. The method of claim 1, wherein the at least one positioning operation comprises a trigger-based ranging (TBR) operation.

3. The method of claim 1, wherein, for each respective PSTA of the one or more PSTAs, the respective location information comprises a location estimate of the respective PSTA, a location measurement performed by the PSTA, or a combination thereof.

4. The method of claim 1, further comprising transmitting one or more location messages indicative of the respective location information received from each respective PSTA of the one or more PSTAs.

5. The method of claim 4, wherein the RSTA and the one or more PSTAs are part of a decentralized device network.

6. The method of claim 4, wherein the RSTA and one or more PSTAs are part of a centralized device network having a controller separate from the RSTA, the method further comprising receiving, from the controller, an acknowledgement of receiving the one or more location messages.

7. The method of claim 1, wherein the RSTA operates as a controller for a device network comprising the RSTA and the one or more PSTAs.

8. The method of claim 1, further comprising, prior to transmitting the reporting trigger frame:
transmitting a polling trigger frame to identify the one or more PSTAs providing the location reports; and
receiving a respective poll acknowledgement from each PSTA of the one or more PSTAs.

9. The method of claim 1, wherein the at least one positioning operation comprises a non-TBR operation.

10. A method of reporting location-related information, performed by a passive station (PSTA), the method comprising:
performing at least one positioning operation without transmitting radio frequency (RF) signals;
determining location information of the PSTA based at least in part on the at least one positioning operation;
subsequent to performing the at least one positioning operation, receiving a reporting trigger frame from a responding station (RSTA), the reporting trigger frame soliciting a location report from the PSTA; and
responsive to receiving the reporting trigger frame, transmitting a location report, the location report comprising the determined location information of the PSTA.

11. The method of claim 10, wherein the at least one positioning operation comprises a trigger-based ranging (TBR) operation.

12. The method of claim 10, further comprising, subsequent to transmitting the location report, receiving one or more location messages from the RSTA, the location information indicative of a respective location of each of one or more additional PSTAs.

13. The method of claim 12, wherein the PSTA and the RSTA are part of a decentralized device network.

14. The method of claim 12, wherein the PSTA and the RSTA are part of a centralized device network having a controller separate from the RSTA.

15. The method of claim 10, wherein the RSTA operates as a controller for a device network comprising the PSTA and the RSTA.

16. The method of claim 10, further comprising, prior to receiving the reporting trigger frame:
receiving a polling trigger frame from the RSTA; and
responsive to receiving the polling trigger frame, transmitting a poll acknowledgement.

17. The method of claim 10, wherein the at least one positioning operation comprises a non-TBR operation.

18. A responding station (RSTA) comprising:
at least one transceiver;
at least one memory; and
at least one processor communicatively coupled with the at least one transceiver and the at least one memory, the at least one processor configured to:
transmit, via the at least one transceiver, a reporting trigger frame subsequent to at least one positioning operation performed by one or more passive stations (PSTAs), the reporting trigger frame soliciting location reports from the one or more PSTAs; and
subsequent to transmitting the reporting trigger frame, receiving, via the at least one transceiver, from each respective PSTA of the one or more PSTAs, a respective location report comprising respective location information of the respective PSTA, wherein the respective location information is determined by the respective PSTA based at least in part on the at least one positioning operation performed by the one or more PSTAs.

19. The RSTA of claim 18, wherein the at least one processor is further configured to transmit one or more location messages indicative of the respective location information received from each respective PSTA of the one or more PSTAs.

20. The RSTA of claim 19, wherein the RSTA and the one or more PSTAs are part of a decentralized device network.

21. The RSTA of claim 19, wherein the at least one processor is further configured to receive, via the at least one transceiver from a controller of a centralized device network of which the RSTA is a part, an acknowledgement of receiving the one or more location messages.

22. The RSTA of claim 18, wherein the RSTA operates as a controller for a device network comprising the RSTA and the one or more PSTAs.

23. The RSTA of claim 18, wherein the at least one processor is further configured to, prior to transmitting the reporting trigger frame:
transmit, via the at least one transceiver, a polling trigger frame to identify the one or more PSTAs; and
receive, via the at least one transceiver, a respective poll acknowledgement from each PSTA of the one or more PSTAs.

24. A passive station (PSTA) comprising:
at least one transceiver;
at least one memory; and
at least one processor communicatively coupled with the at least one transceiver and the at least one memory, the at least one processor configured to:
perform at least one positioning operation without transmitting radio frequency (RF) signals;
determine location information of the PSTA based at least in part on the at least one positioning operation;
subsequent to performing the at least one positioning operation, receive a reporting trigger frame, via the at least one transceiver, from a responding station (RSTA), the reporting trigger frame soliciting a location report from the PSTA; and
responsive to receiving the reporting trigger frame, transmit a location report via the at least one transceiver, the location report comprising the determined location information of the PSTA.

25. The PSTA of claim 24, wherein, to determine the location information of the PSTA, the at least one processor is configured to determine a location estimate of the respective PSTA, obtain a location measurement performed by the PSTA, or perform a combination thereof.

26. The PSTA of claim 24, wherein, to perform the at least one positioning operation, the at least one processor is configured to perform a global navigation satellite system (GNSS)-based positioning operation, a radio network-based positioning operation, a Wi-Fi-based positioning operation, or any combination thereof.

27. The PSTA of claim 24, wherein the at least one processor is further configured to, subsequent to transmitting the location report, receive one or more location messages from the RSTA, the one or more location messages indicative of a respective location of each of one or more additional PSTAs.

28. The PSTA of claim 27, wherein the PSTA is configured to be part of a decentralized device network.

29. The PSTA of claim 27, wherein the PSTA is configured to be part of a centralized device network having a controller separate from the RSTA.

30. The PSTA of claim 24, wherein the at least one processor is further configured to, prior to receiving the reporting trigger frame:
receive a polling trigger frame, via the at least one transceiver, from the RSTA; and
responsive to receiving the polling trigger frame, transmit a poll acknowledgement, via the at least one transceiver.
